(19) United States
(12) Patent Application Publication
(10) Pub. No.: US 2026/0034781 A1
(43) Pub. Date: Feb. 5, 2026

(54) Driving Method Of Liquid Ejecting Apparatus And Liquid Ejecting Apparatus

(71) Applicant: SEIKO EPSON CORPORATION, Tokyo (JP)

(72) Inventor: Satoko UEKAWA, Shiojiri (JP)

(21) Appl. No.: 19/287,932

(22) Filed: Aug. 1, 2025

(30) Foreign Application Priority Data
Aug. 2, 2024 (JP) 2024-127671

(51) Int. Cl. B41J 2/045

(52) U.S. Cl. CPC B41J 2/04591; B41J 2/04541; B41J 2/04563; B41J 2/04581; B41J 2/04588

(57) ABSTRACT

There is provided a driving method of a liquid ejecting apparatus in which a liquid ejects from a first nozzle by driving a first driving element with a first driving signal. The first drive signal includes a first ejection pulse having a first ejection waveform element that changes in potential to eject a liquid from a first nozzle, and a first micro-vibration pulse having a first micro-vibration waveform element that changes in potential to not eject the liquid from the first nozzle. The driving method includes: determining the first ejection pulse; and setting a potential change width of the first micro-vibration waveform element based on a maximum potential change width in the first ejection waveform element and a first upper limit threshold value. The first upper limit threshold value is a value of the potential change width with which the ejection of the liquid is stabilized.

The present application is based on, and claims priority from JP Application Serial Number 2024-127671, filed Aug. 2, 2024, the disclosure of which is hereby incorporated by reference herein in its entirety.

### BACKGROUND

### 1. Technical Field

The present disclosure relates to a driving method of a liquid ejecting apparatus and the liquid ejecting apparatus.

### 2. Related Art

In the related art, a liquid ejecting apparatus having a nozzle that ejects a liquid such as ink onto a medium such as printing paper, a pressure chamber that communicates with the nozzle, and a driving element that is driven to cause a pressure fluctuation in the liquid in the pressure chamber in accordance with a supplied drive signal, is widely used. The drive signal has an ejection pulse having an ejection waveform element that changes in potential to cause the pressure fluctuation for ejecting the liquid from the nozzle in the liquid in the pressure chamber. For example, JP-A-2014-184572 discloses that an amplitude of a drive signal is corrected to correct an ejection amount of a droplet caused by a difference in characteristics of a driving element.

In a liquid ejecting apparatus, in order to alleviate a thickening of the liquid in a nozzle caused by evaporation of a solvent such as moisture contained in the liquid, a drive signal includes a micro-vibration pulse that eliminates the local thickening in the vicinity of the nozzle by micro-vibration of the liquid in the nozzle in addition to an ejection pulse. Even when an amplitude of the micro-vibration pulse is corrected in accordance with the correction of the amplitude of the ejection pulse by applying the technique in the related art described above, the amplitude of the micro-vibration pulse after the correction may not be appropriate.

### SUMMARY

According to an aspect of the present disclosure, there is provided a driving method of a liquid ejecting apparatus including a first ejecting section including a first nozzle that ejects a liquid onto a medium, a first pressure chamber that communicates with the first nozzle, and a first driving element that is driven to cause a pressure fluctuation in the liquid in the first pressure chamber in accordance with a supplied first drive signal, and a first drive signal generation circuit that generates the first drive signal, and the first drive signal including a first ejection pulse having a first ejection waveform element that changes in potential to cause the pressure fluctuation for ejecting the liquid from the first nozzle in the liquid in the first pressure chamber, and a first micro-vibration pulse having a first micro-vibration waveform element that changes in potential to cause the pressure fluctuation without ejecting the liquid from the first nozzle in the liquid in the first pressure chamber, the driving method including: a determination step of determining a waveform shape of the first ejection pulse; and a setting step of setting a potential change width of a potential change waveform element in the first micro-vibration waveform element based on a maximum potential change width in the first ejection waveform element of the first ejection pulse determined in the determination step and a first upper limit threshold value, in which the first upper limit threshold value is an upper limit value of the potential change width of the potential change waveform element in a micro-vibration waveform element with which the ejection of the liquid is stabilized.

According to another aspect of the present disclosure, there is provided a liquid ejecting apparatus including: a first ejecting section including a first nozzle that ejects a liquid onto a medium, a first pressure chamber that communicates with the first nozzle, and a first driving element that is driven to cause a pressure fluctuation in the liquid in the first pressure chamber in accordance with a supplied first drive signal; a first drive signal generation circuit that generates the first drive signal; and a control circuit that controls the first drive signal generation circuit, in which the first drive signal includes a first ejection pulse having a first ejection waveform element that changes in potential to cause the pressure fluctuation for ejecting the liquid from the first nozzle in the liquid in the first pressure chamber, and a first micro-vibration pulse having a first micro-vibration waveform element that changes in potential to cause the pressure fluctuation without ejecting the liquid from the first nozzle in the liquid in the first pressure chamber, the control circuit determines a waveform shape of the first ejection pulse, and sets a potential change width of a potential change waveform element in the first micro-vibration waveform element based on a maximum potential change width in the first ejection waveform element of the determined first ejection pulse and a first upper limit threshold value, and the first upper limit threshold value is an upper limit value of the potential change width of the potential change waveform element in a micro-vibration waveform element with which the ejection of the liquid is stabilized.

### BRIEF DESCRIPTION OF THE DRAWINGS

FIG. 1 is a schematic diagram illustrating a configuration example of a liquid ejecting apparatus according to a first embodiment.

FIG. 2 is a diagram illustrating an electrical configuration of the liquid ejecting apparatus according to the first embodiment.

FIG. 3 is a cross-sectional diagram illustrating an example of a head chip.

FIG. 4 is a diagram describing a switching circuit.

FIG. 5 is a diagram describing a drive signal for generating a supply signal to be supplied to the head chip.

FIG. 6 is a diagram illustrating a flowchart illustrating an example of a method of adjusting the drive signal.

FIG. 7 is a diagram illustrating a flowchart illustrating an example of a determination process.

FIG. 8 is a diagram illustrating a flowchart illustrating an example of a setting process.

FIG. 9 is a graph describing a candidate value.

FIG. 10 is a diagram illustrating an electrical configuration of another liquid ejecting apparatus.

FIG. 11 is a diagram describing another drive signal.

FIG. 12 is a diagram illustrating a flowchart illustrating an example of a method of adjusting the other drive signal.

FIG. 13 is a diagram illustrating a flowchart illustrating an example of a threshold value changing process.

FIG. 14 is a graph describing a modification example of an upper limit micro-vibration threshold value and another upper limit micro-vibration threshold value.

FIG. 15 is a diagram illustrating a flowchart illustrating an example of a setting process according to a second embodiment.

FIG. 16 is a graph describing an example of an adjustment result of the other drive signal.

FIG. 17 is a diagram illustrating an electrical configuration of a liquid ejecting apparatus according to a first modification example.

FIG. 18 is a graph describing an example of an adjustment result of still another drive signal.

FIG. 19 is a diagram illustrating a flowchart illustrating an example of a determination process in a second modification example.

FIG. 20 is a graph describing an example of an adjustment result of the drive signal in the second modification example.

### DESCRIPTION OF EMBODIMENTS

Hereinafter, appropriate embodiments according to the present disclosure will be described with reference to the accompanying drawings. In the drawings, dimensions or scales of each section are appropriately different from actual ones, and for easy understanding, some portions are schematically illustrated. In addition, the scope of the present disclosure is not limited to the forms unless the present disclosure is particularly limited in the following description.

The following description will be performed by using an X-axis, a Y-axis, and a Z-axis that intersect each other as appropriate. In the following, one direction along the X-axis is an X1 direction, and a direction opposite to the X1 direction is an X2 direction. In the same manner, directions opposite to each other along the Y-axis are a Y1 direction and a Y2 direction. Mutually opposite directions along the Z-axis are a Z1 direction and a Z2 direction.

Here, typically, the Z-axis is a vertical axis, and the Z2 direction corresponds to a down direction in the vertical direction. Meanwhile, the Z-axis need not be the vertical axis. In addition, although the X-axis, the Y-axis, and the Z-axis are typically orthogonal to each other, the axes are not limited thereto and may intersect at an angle within the range of, for example, 80 degrees or more and 100 degrees or less.

### A: First Embodiment

### A1: Overall Configuration of Liquid Ejecting Apparatus

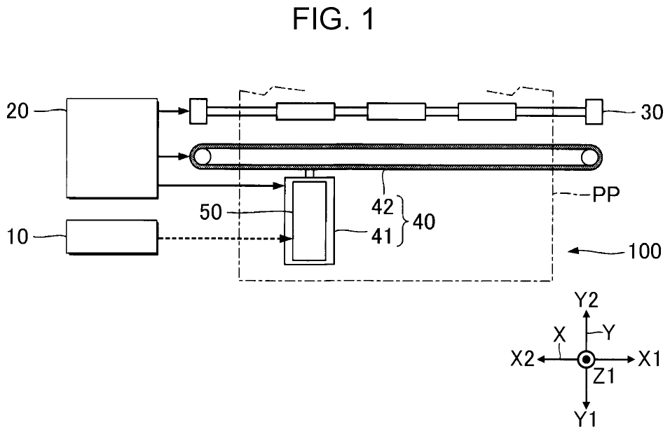

FIG. 1 is a schematic diagram illustrating a configuration example of a liquid ejecting apparatus 100 according to a first embodiment. The liquid ejecting apparatus 100 is an ink jet printing apparatus that ejects an ink, which is an example of a liquid, onto a medium PP in a form of a droplet. The medium PP is, for example, printing paper. The medium PP is not limited to the printing paper, and may be, for example, a printing target of any material such as a resin film or cloth.

As illustrated in FIG. 1, the liquid ejecting apparatus 100 includes a liquid container 10, a control unit 20, a transport mechanism 30, a moving mechanism 40, and a liquid ejecting head 50.

The liquid container 10 stores inks. Specific aspects of the liquid container 10 include, for example, a cartridge that can be attached to and detached from the liquid ejecting apparatus 100, a bag-shaped ink pack formed of a flexible film, and an ink tank that can be refilled with the inks. A type of the ink stored in the liquid container 10 is optional.

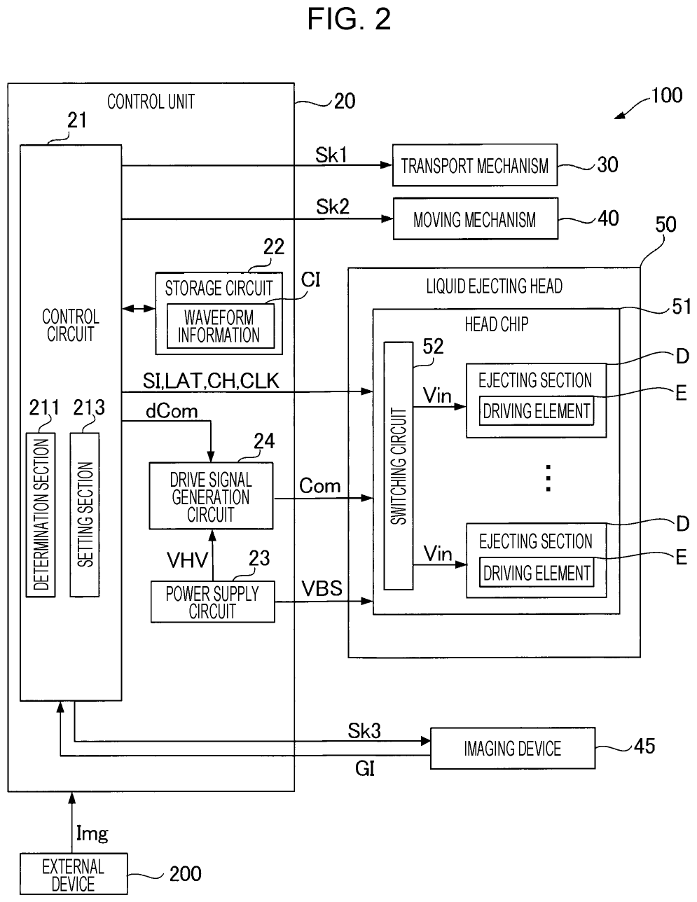

The control unit 20 controls an operation of each element of the liquid ejecting apparatus 100. The control unit 20 includes, for example, one or a plurality of processing circuits such as a central processing unit (CPU) or a field-programmable gate array (FPGA), and one or a plurality of storage circuits such as a semiconductor memory. A detailed configuration of the control unit 20 will be described below with reference to FIG. 2.

The transport mechanism 30 transports the medium PP in the Y1 direction under control by the control unit 20. The moving mechanism 40 reciprocates the liquid ejecting head 50 along the X-axis under the control of the control unit 20. The moving mechanism 40 includes a substantially box-shaped carriage 41 that houses the liquid ejecting head 50, and an endless transport belt 42 to which the carriage 41 is fixed. The number of liquid ejecting heads 50 mounted in the carriage 41 is not limited to one, and may be plural. Further, the liquid container 10 may be mounted in the carriage 41, in addition to the liquid ejecting head 50.

The liquid ejecting head 50 ejects the ink supplied from the liquid container 10 onto the medium PP from each of a plurality of nozzles N under the control of the control unit 20. The ejection is performed in parallel with the transport of the medium PP via the transport mechanism 30 and the reciprocating movement of the liquid ejecting head 50 via the moving mechanism 40, so that an image is formed by the ink on a surface of the medium PP.

### A2: Electrical Configuration of Liquid Ejecting Apparatus 100

FIG. 2 is a diagram illustrating an electrical configuration of the liquid ejecting apparatus 100 according to the first embodiment. As illustrated in FIG. 2, the liquid ejecting head 50 has one head chip 51. Meanwhile, the liquid ejecting head 50 may have a plurality of head chips 51.

The head chip 51 includes a switching circuit 52 and M ejecting sections D. In the following, when the number of ejecting sections D included in the head chip 51 is M, in order to distinguish each of the M ejecting sections D, the ejecting section D may be referred to as an ejecting section D[m] using a subscript [m]. Meanwhile, M is an integer of 2 or more, and m is an integer of 1 or more and M or less. In addition, in the liquid ejecting apparatus 100, an element included in the ejecting section D may also be described using a subscript [m].

Under the control of the control unit 20, the switching circuit 52 switches whether or not to supply a drive signal Com output from the control unit 20 to each of the M ejecting sections D as a supply signal Vin. In the present embodiment, the head chip 51 includes a switching circuit 52, and the head chip 51 may not include the switching circuit 52.

The control unit 20 includes a control circuit 21, a storage circuit 22, a power supply circuit 23, and a drive signal generation circuit 24.

The control circuit 21 has a function of controlling an operation of each section of the liquid ejecting apparatus 100 and a function of processing various types of data. The control circuit 21 includes, for example, a processor such as one or more CPUs. The control circuit 21 may include a programmable logic device such as an FPGA, instead of or in addition to the CPU. In addition, when the control circuit 21 includes a plurality of processors, the plurality of processors may be mounted on different substrates or the like.

Here, by executing the program, the control circuit 21 generates a control signal Sk1 and a control signal Sk2, a printing data signal SI, a waveform designation signal dCom, a latch signal LAT, a change signal CH, and a clock signal CLK as signals for controlling the operation of each section of the liquid ejecting apparatus 100.

The control signal Sk1 is a signal for controlling driving of the transport mechanism 30. The control signal Sk2 is a signal for controlling driving of the moving mechanism 40. The printing data signal SI is a digital signal for designating an operation state of a driving element E. The latch signal LAT and the change signal CH are timing signals that are used in combination with the printing data signal SI and that define an ink ejection time from each nozzle N of the head chip 51.

The control circuit 21 reads a program stored in the storage circuit 22 and executes the read program to function as a determination section 211 and a setting section 213. The determination section 211 and the setting section 213 will be described below.

The storage circuit 22 stores various programs executed by the control circuit 21, various types of data such as image data Img processed by the control circuit 21, and waveform information CI for generating the waveform designation signal dCom. The storage circuit 22 includes, for example, a semiconductor memory of one or both of volatile memories such as a random-access memory (RAN) and non-volatile memories such as a read only memory (ROM), an electrically erasable programmable read-only memory (EEPROM) or a programmable ROM (PROM). The image data Img is supplied from an external device 200 such as a personal computer or a digital camera. The storage circuit 22 may be configured as a part of the control circuit 21.

The power supply circuit 23 receives power supplied from a commercial power supply (not illustrated) and generates various predetermined potentials. The generated various potentials are appropriately supplied to each section of the liquid ejecting apparatus 100. The power supply circuit 23 generates, for example, a power supply potential VHV and an offset potential VBS. The offset potential VBS is supplied to the liquid ejecting head 50. In addition, the power supply potential VHV is supplied to the drive signal generation circuit 24.

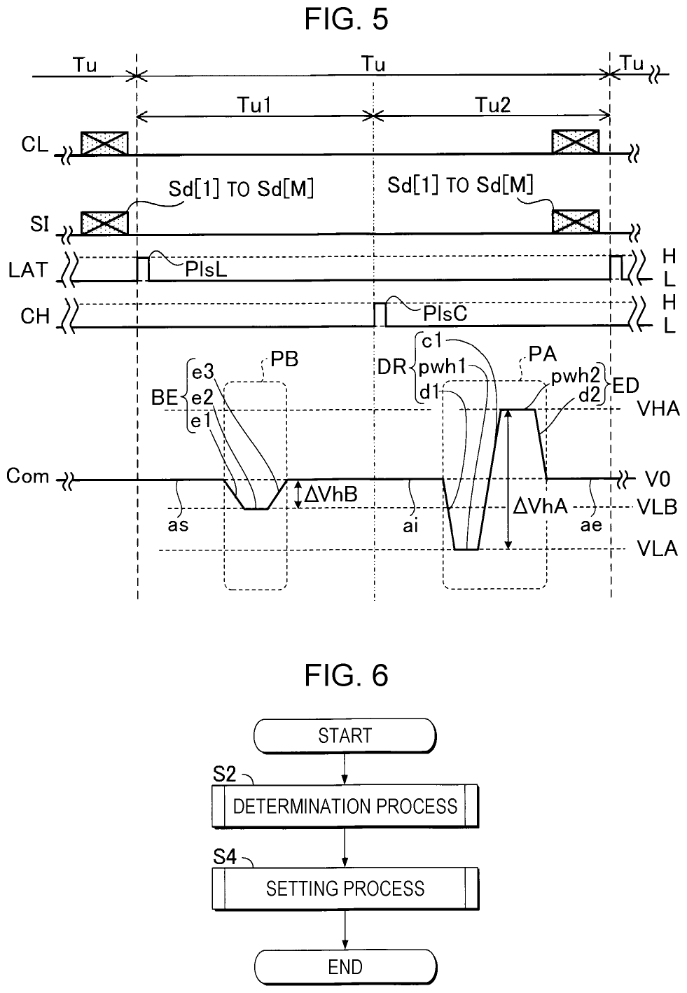

The drive signal generation circuit 24 is a circuit that repeatedly generates the drive signal Com for driving each driving element E included in each ejecting section D. Specifically, the drive signal generation circuit 24 includes, for example, a DA conversion circuit and an amplifier circuit. In the drive signal generation circuit 24, the DA conversion circuit converts a waveform designation signal dCom from the control circuit 21 from a digital signal to an analog signal. The drive signal Com is generated by the amplifier circuit amplifying the analog signal by using the power supply potential VHV from the power supply circuit 23. Among waveforms included in the drive signal Com, a signal of a waveform actually supplied to the driving element E is the supply signal Vin described above. The waveform designation signal dCom is a digital signal for defining a waveform of the drive signal Com. The control circuit 21 generates a waveform designation signal dCom based on the waveform information CI. Details of the waveform information CI will be described below with reference to FIG. 5.

Further, the liquid ejecting apparatus 100 includes an imaging device 45 to measure an ejection amount of the liquid from the ejecting section D. The imaging device 45 is an apparatus that images the flying liquid ejected from the ejecting section D. Specifically, the imaging device 45 includes, for example, an imaging optical system and an imaging element. The imaging optical system is an optical system including at least one imaging lens, and may include various optical elements such as a prism, or may include a zoom lens, a focus lens, or the like. The imaging element is, for example, a CCD image sensor, a CMOS image sensor, or the like. CCD is an abbreviation for charge coupled device. CMOS is an abbreviation for complementary MOS.

The control circuit 21 transmits an imaging instruction Sk3 to the imaging device 45. When the imaging instruction Sk3 is received, the imaging device 45 transmits image information GI indicating an image in which the flying liquid is captured, to the control circuit 21. The control circuit 21 acquires a weight of the flying droplet as the ejection amount based on the image information GI.

A method of measuring the ejection amount is not limited to the method described above. For example, the liquid ejecting apparatus 100 can also measure the ejection amount by using a device that captures an image of the liquid that lands on the medium PP or the like without using the imaging device 45, or by using an electronic balance that measures a mass of the liquid ejected from the ejecting section D.

### A3: Specific Structure of Head Chip 51

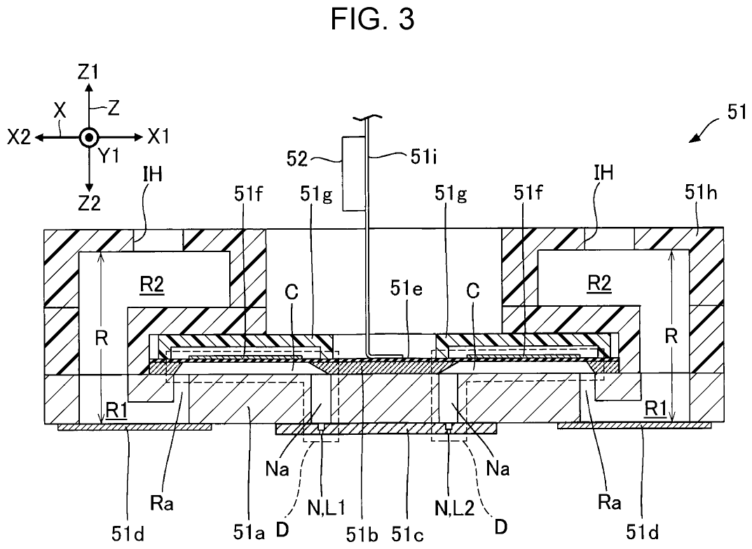

FIG. 3 is a cross-sectional diagram illustrating an example of the head chip 51. As illustrated in FIG. 3, the head chip 51 has M nozzles N arranged in a direction along the Y-axis. The M nozzles N are divided into a first row L1 and a second row L2 which are arranged at intervals in a direction along the X-axis. Each of the first row L1 and the second row L2 is a set of 0.5×M nozzles N arranged linearly in a direction along the Y-axis.

The head chip 51 has a substantially symmetrical configuration in the direction along the X-axis. Meanwhile, positions of the plurality of nozzles N in the first row L1 and the plurality of nozzles N in the second row L2 in the direction along the Y-axis may match or differ from each other. FIG. 3 illustrates a configuration in which the positions of the plurality of nozzles N in the first row L1 and the plurality of nozzles N in the second row L2 in the direction along the Y-axis match with each other.

As illustrated in FIG. 3, the head chip 51 includes a flow path substrate 51a, a pressure chamber substrate 51b, a nozzle plate 51c, a vibration absorbing body 51d, a diaphragm 51e, a plurality of driving elements 51f, a protective plate 51g, a case 51h, and a wiring substrate 51i.

The flow path substrate 51a and the pressure chamber substrate 51b are stacked in this order in the Z1 direction, and form a flow path for supplying inks to the M nozzles N. The diaphragm 51e, M driving elements 51f, the protective plates 51g, the case 51h, and the wiring substrate 51i are installed in a region located in the Z1 direction with respect to a stacked body formed by the flow path substrate 51a and the pressure chamber substrate 51b. On the other hand, the nozzle plate 51c and the vibration absorbing body 51d are installed in a region located in the Z2 direction with respect to the stacked body. Each element of the head chip 51 is schematically a plate-shaped member elongated in the Y direction, and the elements are joined to each other by, for example, using an adhesive. Hereinafter, each element of the head chip 51 will be described in order.

The nozzle plate 51c is a plate-shaped member provided with the M nozzles N for each of the first row L1 and the second row L2. Each of the M nozzles N is a through-hole through which the ink passes. The nozzle plate 51c is manufactured by, for example, processing a silicon single crystal substrate by a semiconductor manufacturing technique using a processing technique such as dry etching or wet etching. Here, other known methods and materials may be used as appropriate for manufacturing the nozzle plate 51c. In addition, although a cross-sectional shape of the nozzle N is typically circular, the cross-sectional shape is not limited to this, and may be, for example, a non-circular shape such as a polygonal or elliptical shape.

The flow path substrate 51a is provided with a space R1, M supply flow paths Ra, and M communication flow paths Na, for each of the first row L1 and the second row L2. The space R1 is an elongated opening extending in the direction along the Y-axis in a plan view in the direction along the Z-axis. Each of the supply flow path Ra and the communication flow path Na is a through-hole formed for each nozzle N. Each supply flow path Ra communicates with the space R1.

The pressure chamber substrate 51b is a plate-shaped member provided with M pressure chambers C referred to as cavities, for each of the first row L1 and the second row L2. The M pressure chambers C are arranged in the direction along the Y-axis. Each of the pressure chambers C is an elongated space formed for each nozzle N and extending in the direction along the X-axis in the plan view. Each of the flow path substrate 51a and the pressure chamber substrate 51b is manufactured by, for example, processing a silicon single crystal substrate by a semiconductor manufacturing technique in the same manner as the nozzle plate 51c described above. Here, other known methods and materials may be used as appropriate for manufacturing each of the flow path substrate 51a and the pressure chamber substrate 51b.

The pressure chamber C is a space located between the flow path substrate 51a and the diaphragm 51e. For each of the first row L1 and the second row L2, the M pressure chambers C are arranged in the direction along the Y-axis. In addition, the pressure chamber C communicates with each of the communication flow path Na and the supply flow path Ra. Therefore, the pressure chamber C communicates with the nozzle N via the communication flow path Na, and communicates with the space R1 via the supply flow path Ra.

The diaphragm 5ie is disposed on a surface of the pressure chamber substrate 51b facing the Z1 direction. The diaphragm 51e is a plate-shaped member that can elastically vibrate. The diaphragm 51e has, for example, a first layer and a second layer, and the first layer and the second layer are stacked in this order in the Z1 direction. The first layer is an elastic film made of silicon oxide (SiO₂), for example. The elastic film is formed, for example, by thermally oxidizing one surface of a silicon single crystal substrate. The second layer is an insulating film made of zirconium oxide (ZrO₂), for example. The insulating film is formed, for example, by forming a zirconium layer by a sputtering method and thermally oxidizing the layer. The diaphragm 51e is not limited to the configuration in which the first layer and the second layer are stacked described above, and may be composed of, for example, a single layer or three or more layers.

On the surface of the diaphragm 51e facing the Z1 direction, the M driving elements 51f corresponding to the nozzles N are arranged, for each of the first row L1 and the second row L2. Each driving element 51f is a passive element deformed by the drive signal Com being supplied. Each driving element 51f has an elongated shape extending in the direction along the X-axis in the plan view. The M driving elements 51f are arranged in the direction along the Y-axis to correspond to the M pressure chambers C. The driving element 51f overlaps the pressure chamber C in the plan view.

Each driving element 51f is a piezoelectric element, and although not illustrated, the driving element 51f has a first electrode, a piezoelectric layer, and a second electrode, which are stacked in this order in the Z1 direction. One of the first electrode and the second electrode is an individual electrode that is disposed to be separated from each other for each driving element 51f, and the supply signal Vin is applied to the one electrode. The other electrode of the first electrode and the second electrode is a band-shaped common electrode extending in the direction along the Y-axis to be continuous over 0.5×the M driving elements 51f, and the offset potential VBS is supplied to the other electrode. Examples of metal materials of the electrodes include metal materials such as platinum (Pt), aluminum (Al), nickel (Ni), gold (Au), and copper (Cu), and among these, one type can be used alone, or two or more types can be used in combination in an alloy or stacked aspect. The piezoelectric layer is made of a piezoelectric material such as lead zirconate titanate (Pb(Zr, Ti)O₃), and for example, has a band shape extending in the direction along the Y-axis to be continuous over 0.5×the M driving elements 51f. Meanwhile, the piezoelectric layer may be integrated over 0.5×the M driving elements 51f. In this case, the piezoelectric layer is provided with a through-hole penetrating the piezoelectric layer to extend in the direction along the X-axis in a region corresponding to, in the plan view, a gap between the pressure chambers C adjacent to each other. When the diaphragm 51e vibrates in conjunction with the above deformation of the driving elements 51f, the pressures in the pressure chambers C fluctuate, and the ink is ejected from the nozzles N.

The protective plates 51g are a plate-shaped members installed on the surface of the diaphragm 51e facing the Z1 direction, and protect the plurality of M driving elements 51f and reinforce a mechanical strength of the diaphragm 51e. Here, the M driving elements 51f are housed between the protective plate 51g and the diaphragm 51e. For example, the protective plate 51g is made of a resin material.

The case 51h is a member for storing the ink to be supplied to the plurality of M pressure chambers C. For example, the case 51h is made of a resin material. The case 51h is provided with a space R2 for each of the first row L1 and the second row L2. The space R2 is a space communicating with the space R1 described above, and functions as a reservoir R for storing ink supplied to the M pressure chambers C, together with the space R1. The case 51h is provided with an inlet IH for supplying the ink to each reservoir R. The ink in each reservoir R is supplied to the pressure chamber C via each supply flow path Ra.

The vibration absorbing body 5id is also referred to as a compliance substrate, is a flexible resin film forming a wall surface of the reservoir R, and absorbs the pressure fluctuation in the ink in the reservoir R. The vibration absorbing body 51d may be a flexible thin plate made of metal. A surface of the vibration absorbing body 51d facing the Z1 direction is joined to the flow path substrate 51a by using an adhesive or the like.

The wiring substrate 51i is mounted on the surface of the diaphragm 51e facing the Z1 direction, and is a mounting component for electrically coupling a control unit 20 and the head chip 51. The wiring substrate 51i is, for example, a flexible wiring substrate such as a chip on film (COF), a flexible printed circuit (FPC), and a flexible flat cable (FFC). The switching circuit 52 for supplying a drive voltage to each driving element 51f is mounted on the wiring substrate 51i of the present embodiment.

As illustrated in FIG. 3, one ejecting section D includes one driving element 51f, one pressure chamber C, and one nozzle N. That is, the M driving elements 51f correspond to the M pressure chambers C on a one-to-one basis. As understood from FIG. 3 and the like, the driving element Sif corresponding to the pressure chamber C means the driving element Sif that overlaps a part or an entirety of the pressure chamber C in the plan view in the Z2 direction. When the drive signal Com is supplied to the driving element Sif based on the printing data signal SI, the ejecting section D ejects the ink in the pressure chamber C from the nozzle N by driving the driving element 51f with the drive signal Com.

### A4: Driving of Driving Element 51f

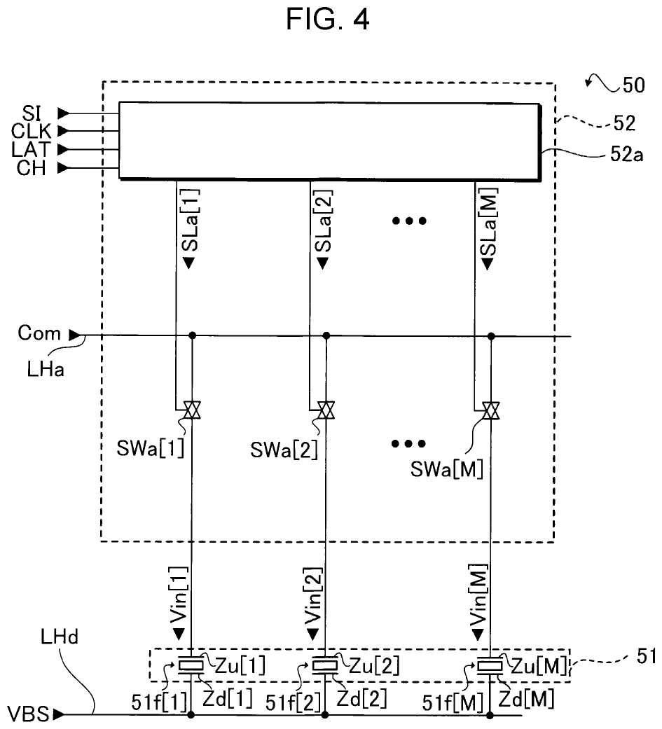

FIG. 4 is a diagram describing the switching circuit 52. The driving element 51f is driven by the supply signal Vin from the switching circuit 52. Hereinafter, the switching circuit 52 will be described with reference to FIG. 4.

As illustrated in FIG. 4, a wiring LHa is coupled to the switching circuit 52. The wiring LHa is a signal line that transmits the drive signal Com. In FIG. 4, for each of the integers m from 1 to M, one of the first electrode and the second electrode of the driving element 51f described above is illustrated as an electrode Zd[m], and the other is illustrated as an electrode Zu[m]. A wiring LHd is coupled to the electrode Zd[m]. The wiring LHd is a power supply line to which the offset potential VBS is supplied.

The switching circuit 52 includes M switches SWa, which are switches SWa[1] to SWa[M], and a coupling state designation circuit 52a that designates a coupling state of the switches.

For each of the integers m from 1 to M, the switch SWa[m] is a switch that switches between conduction and non-conduction between the wiring LHa for transmitting the drive signal Com and the electrode Zu[m] of the driving element 51f[m]. Each of these switches is, for example, a transmission gate.

The coupling state designation circuit 52a generates coupling state designation signals SLa[1] to SLa[M] for designating ON or OFF of the switches SWa[1] to SWa[M] based on the clock signal CLK, the printing data signal SI, the latch signal LAT, and the change signal CH supplied from the control circuit 21.

For example, although not illustrated, the coupling state designation circuit 52a includes a plurality of transfer circuits, a plurality of latch circuits, and a plurality of decoders to correspond to the driving elements E[1] to E[M] on a one-to-one basis. Among these, the printing data signal SI is supplied to the transfer circuit. Here, the printing data signal SI includes an individual designation signal Sd illustrated in FIG. 5, for each driving element E. The individual designation signal Sd is serially supplied, and for example, the individual designation signal Sd is sequentially transferred to the plurality of transfer circuits in synchronization with the clock signal CLK. The latch circuit latches the individual designation signal Sd supplied to the transfer circuit based on the latch signal LAT. In addition, the decoder generates the coupling state designation signal SLa[m], a coupling state designation signal SLb[m], and a coupling state designation signal SLc[m], for each of the integers m from 1 to M, based on the individual designation signal Sd and the latch signal LAT.

For each of the integers m from 1 to M, ON or OFF of the switch SWa[m] is switched according to the coupling state designation signal SLa[m] generated as described above. For example, the switch SWa[m] is in an on state when the coupling state designation signal SLa[m] is at a high level and is in an off state when the coupling state designation signal SLa[m] is at a low level. As described above, the switching circuit 52 supplies a part or an entirety of a waveform included in the drive signal Com as the supply signal Vin to the driving elements 51f of one or more ejecting sections D selected from the M ejecting sections D.

### A5: Drive Signal Com

FIG. 5 is a diagram describing the drive signal Com for generating the supply signal Vin supplied to the head chip 51. In the present embodiment, an operation period of the liquid ejecting apparatus 100 includes one or a plurality of unit periods Tu. In general, the liquid ejecting apparatus 100 forms an image indicated by the image data Img by ejecting a liquid one or a plurality of times from each ejecting section D over the plurality of unit periods Tu continuously or intermittently.

As illustrated in FIG. 5, the control circuit 21 outputs the latch signal LAT having a pulse PlsL and the change signal CH having a pulse PlsC. Therefore, the control circuit 21 defines the unit period Tu as a period from a rising edge of the pulse PlsL to a rising edge of the next pulse PlsL. A specific length or period of the unit period Tu is not particularly limited. The control circuit 21 divides the unit period Tu into two control periods Tu1 and Tu2 by the pulse PlsC.

The printing data signal SI includes individual designation signals Sd[1] to Sd[M] that designate a mode of driving of the ejecting sections D[1] to D[M] in each unit period Tu. As described above, the coupling state designation circuit 52a generates the coupling state designation signal SLa[m] based on the individual designation signal Sd[m] in the unit period Tu, for each of the integers m from 1 to M.

The individual designation signal Sd[m] is a signal that designates one of two driving modes of ink ejection and micro-vibration with respect to the ejecting section D[m] in each unit period Tu. The driving mode of micro-vibration is to minutely vibrate a liquid level in the nozzle N by driving the driving element E such that an ink is not ejected from the nozzle N to prevent the ink in the nozzle N from being thickened or the like. Hereinafter, the liquid level of the nozzle N may be referred to as a “meniscus”.

As illustrated in FIG. 5, the drive signal generation circuit 24 outputs the drive signal Com having a start potential maintenance element as, a micro-vibration pulse PB, a coupling element ai, an ejection pulse PA, and an end potential maintenance element ae in this order, in one unit period Tu. The start potential maintenance element as, the micro-vibration pulse PB, and a part including a start point of the coupling element ai are provided within the control period Tu1. Another part including an end point of the coupling element ai, the ejection pulse PA, and the end potential maintenance element ae are provided within the control period Tu2.

The start potential maintenance element as is an element that maintains a reference potential V0 from a start of one unit period Tu to a start of the micro-vibration pulse PB. The coupling element ai is an element that maintains the reference potential V0 from an end of the micro-vibration pulse PB to a start of the ejection pulse PA. The end potential maintenance element ae is an element that maintains the reference potential V0 from an end of the ejection pulse PA to an end of one unit period Tu.

The micro-vibration pulse PB has a micro-vibration waveform element BE. The micro-vibration waveform element BE is a trapezoidal wave, and changes in potential to cause a pressure fluctuation in an ink in the pressure chamber C without ejecting the ink from the nozzle N. The micro-vibration waveform element BE has an expansion element e1, a maintenance element e2, and a contraction element e3 in this order. The expansion element e1 changes in potential from the reference potential V0 to a minimum potential VLB of the micro-vibration pulse PB. The minimum potential VLB is the minimum potential in the micro-vibration pulse PB. Meanwhile, as understood from FIG. 5, the minimum potential VLB is a potential higher than a minimum potential VLA. The maintenance element e2 is an element that maintains the minimum potential VLB. The contraction element e3 is an element that returns from the minimum potential VLB to the reference potential V0.

The ejection pulse PA has an ejection waveform element DR and a residual vibration suppression element ED in this order. The ejection waveform element DR changes in potential such that the pressure fluctuation for ejecting the ink from the nozzle N is generated in the ink in the pressure chamber C. The residual vibration suppression element ED attenuates the pressure fluctuation of the liquid in the pressure chamber C remaining after the droplet is ejected from the nozzle N.

The ejection waveform element DR has a filling element d1, a potential maintenance element pwh1, and an ejecting element c1 in this order. The filling element d1 changes from the reference potential V0 to the minimum potential VLA to generate a negative pressure in the pressure chamber C. The minimum potential VLA is the minimum potential in the ejection pulse PA. An end tip of the filling element d1 is coupled to a start tip of the potential maintenance element pwh1. The potential maintenance element pwh1 maintains the minimum potential VLA. An end tip of the potential maintenance element pwh1 is coupled to the ejecting element c1. The ejecting element c1 changes from the minimum potential VLA to the maximum potential VHA to generate a positive pressure in the pressure chamber C. The maximum potential VHA is the maximum potential in the ejection pulse PA. When receiving the supply of the ejection waveform element DR, the driving element E generates a negative pressure in the pressure chamber C by the filling element d1, and then generates a positive pressure in the pressure chamber C by the ejecting element c1, thereby ejecting droplets from the nozzle N.

The residual vibration suppression element ED has a vibration suppression maintenance element pwh2 and a vibration suppression expansion element d2 in this order. The vibration suppression maintenance element pwh2 maintains a constant potential from an end tip of the ejecting element c1. In the example in FIG. 5, the maximum potential VHA is maintained. The vibration suppression expansion element d2 starts a potential change from an end tip of the vibration suppression maintenance element pwh2 and expands the pressure chamber C. The vibration suppression expansion element d2 changes the potential from the maximum potential VHA to the reference potential V0.

When the individual designation signal Sd[m] designates micro-vibration for the ejecting section D[m] for each of the integers m from 1 to M, the coupling state designation circuit 52a sets the individual designation signal Sd[m] to a high level in the control period Tu1 and to a low level in the control period Tu2. In this case, the ejecting section D[m] is driven by the micro-vibration pulse PB in the control period Tu1 to minutely vibrate the ink in the vicinity of the nozzle N.

When the individual designation signal Sd[m] designates the ejection of the ink with respect to the ejecting section D[m] for each of the integers m from 1 to M, the coupling state designation circuit 52a sets the individual designation signal Sd[m] to a low level in the control period Tu1 and to a high level in the control period Tu2. In this case, the ejecting section D[m] is driven by the ejection pulse PA in the control period Tu2 to eject the ink.

In the following description, for the maximum potential change width in the ejection waveform element DR, in the first embodiment, an absolute value of a potential difference between the minimum potential VLA and the maximum potential VHA may be referred to as a potential difference ΔVhA. In the same manner, for the maximum potential change width in the micro-vibration waveform element BE, in the first embodiment, an absolute value of a potential difference between the minimum potential VLB and the reference potential V0 may be described as a potential difference ΔVhB.

The waveform information CI illustrated in FIG. 2 indicates a waveform shape included in the drive signal Com. Specifically, the waveform information CI has end tip information including information indicating a time of an end tip of each element included in the drive signal Com and information indicating a potential of the end tip. For example, the waveform information CI has end tip information of the start potential maintenance element as, end tip information of the expansion element e1, end tip information of the maintenance element e2, end tip information of the contraction element e3, end tip information of the coupling element ai, end tip information of the filling element d1, end tip information of the potential maintenance element pwh1, end tip information of the ejecting element c1, end tip information of the vibration suppression maintenance element pwh2, end tip information of the vibration suppression expansion element d2, and end tip information of the end potential maintenance element ae. Information indicating a time of an end tip included in the end tip information of the end potential maintenance element ae indicates one unit period Tu.

A manufacturer of the head chip 51 manufactures the head chip 51 in large quantities, and stores, in the storage circuit 22, the reference waveform information CI for generating the reference drive signal Com including the ejection pulse PA for ejecting an ejection amount assumed by the manufacturer of the head chip 51 and the micro-vibration pulse PB for vibrating the ink in the nozzle N to a degree with which the ejection of the ink can be stabilized, with respect to the average head chip 51 among the head chips 51 manufactured in large quantities. Hereinafter, the reference drive signal Com may be referred to as a “reference drive signal Com-S”.

In addition, the manufacturer of the head chip 51 may be referred to as a “head manufacturer”. Further, the ejection amount assumed by the head manufacturer may be referred to as an “assumed ejection amount”. Further, the ejection pulse PA included in the reference drive signal Com-S may be referred to as a “reference ejection pulse PA-S”, and the micro-vibration pulse PB included in the reference drive signal Com-S may be referred to as a “reference micro-vibration pulse PB-S”. The potential difference ΔVhA of the reference ejection pulse PA-S may be referred to as a reference potential difference ΔVhA-S. The potential difference ΔVhB of the reference micro-vibration pulse PB-S may be referred to as a reference potential difference ΔVhB-S. The assumed ejection amount is an example of a “predetermined amount”. The ejection waveform element DR of the reference ejection pulse PA-S is an example of a “reference ejection waveform element”.

The drive signal Com is an example of a “first drive signal”. The drive signal generation circuit 24 is an example of a “first drive signal generation circuit”. The ejection pulse PA included in the drive signal Com is an example of a “first ejection pulse”, and the micro-vibration pulse PB included in the drive signal Com is an example of a “first micro-vibration pulse”. The ejection waveform element DR included in the ejection pulse PA is an example of a “first ejection waveform element”. The micro-vibration waveform element BE included in the micro-vibration pulse PB is an example of a “first micro-vibration waveform element”.

### A6: Regarding Adjustment of Drive Signal Com

A certain manufacturing error may occur in the head chip 51. Further, due to the manufacturing error, an assumed ejection amount and an ejection amount of the head chip 51 may be different from each other. In order to match the ejection amount of the head chip 51 with the assumed ejection amount, it is considered to correct the ejection pulse PA.

As a method of correcting the ejection pulse PA, it is considered to correct the potential difference ΔVhA such that the assumed ejection amount is to be ejected. For example, when the reference ejection pulse PA-S is supplied to the head chip 51 to be corrected and a first amount of ink less than the assumed ejection amount is ejected from the nozzle N, the control circuit 21 can increase the ejection amount by correcting the ejection pulse PA such that the potential difference ΔVhA obtained by multiplying a value more than 1 based on the first amount and the assumed ejection amount by the reference potential difference ΔVhA-S is set. In addition, when the reference ejection pulse PA-S is supplied to the head chip 51 to be corrected and a second amount of ink exceeding the assumed ejection amount is ejected from the nozzle N, the control circuit 21 can reduce the ejection amount by correcting the ejection pulse PA such that the potential difference ΔVhA obtained by multiplying a value less than 1 based on the second amount and the assumed ejection amount by the reference potential difference ΔVhA-S is set.

On the other hand, with the micro-vibration pulse PB, the ink is not ejected, and thus the same method as the correction of the ejection pulse PA cannot be applied. Therefore, an aspect is conceivable in which by using a correction result of the potential difference ΔVhA, the micro-vibration pulse PB is corrected such that the potential difference ΔVhB obtained by multiplying a ratio of the potential difference ΔVhA to the reference potential difference ΔVhA-S by the reference potential difference ΔVhB-S is set. Meanwhile, in this aspect, the potential difference αVhB of the micro-vibration pulse PB after the correction may not be appropriate. Specifically, when a diameter of the nozzle N is more than a shape assumed by the manufacturer of the head chip 51 due to a manufacturing error, a meniscus is likely to vibrate and the ejection amount at the reference potential difference ΔVIA-S is likely to be increased. Therefore, the ratio of the potential difference ΔVhA of the assumed ejection amount to the reference potential difference ΔVhA-S is relatively low, and in the potential difference ΔVhB of the micro-vibration pulse PB after the correction obtained by multiplying the ratio by the reference potential difference ΔVhB-S, a situation in which the vibration of the ink in the nozzle N by the micro-vibration pulse PB is insufficient and thickening of the ink cannot be eliminated may occur. In addition, when the diameter of the nozzle N is less than the shape assumed by the manufacturer of the head chip 51 due to the manufacturing error, the meniscus is less likely to vibrate and the ejection amount at the reference potential difference ΔVhA-S is likely to be decreased. Therefore, the ratio of the potential difference ΔVhA of the assumed ejection amount to the reference potential difference ΔVhA-S is relatively high, and in the potential difference ΔVhB of the micro-vibration pulse PB after the correction obtained by multiplying the ratio by the reference potential difference αVhB-S, the vibration of the ink in the nozzle N may become excessive due to the micro-vibration pulse PB, and the stable subsequent ejection of the ink from the nozzle by the ejection pulse PA cannot be ensured. The fact that the stable ejection of the ink cannot be ensured means, for example, that an ejection direction of the ink deviates from a predetermined direction, the ink is not ejected from the nozzle N, and the ejection amount of the ink varies.

Therefore, the control circuit 21 adjusts the potential change width of the potential change waveform element included in the micro-vibration pulse PB based on the potential difference ΔVhA of the ejection pulse PA and an upper limit micro-vibration threshold value BPth. The upper limit micro-vibration threshold value BPth is an upper limit value of the potential difference ΔVhB, which is a potential change width of a potential change waveform element included in the micro-vibration pulse PB with which the ejection of ink when the driving element E is driven by the ejection pulse PA in the next unit period Tu starting from an end tip of the unit period Tu in which the driving element E is driven by the micro-vibration pulse PB can be stabilized. Preferably, the potential change width is the largest potential change width in each potential change width of the potential change waveform element included in the micro-vibration pulse PB. For example, the head manufacturer stores the upper limit micro-vibration threshold value BPth corresponding to the potential change waveform element having the largest potential change width among the potential change waveform elements included in the micro-vibration pulse PB in the storage circuit 22. In the first embodiment, the potential change waveform element having the largest potential change width among the potential change waveform elements included in the micro-vibration pulse PB will be described as the expansion element e1 and the contraction element e3. That is, in the first embodiment, the control circuit 21 sets a potential change width in the expansion element e1 and the contraction element e3, that is, the potential difference ΔVhB based on the potential difference ΔVhA and the upper limit micro-vibration threshold value BPth. The expansion element e1 and the contraction element e3 are examples of a “potential change waveform element”. When the potential difference ΔVhB exceeds the upper limit micro-vibration threshold value BPth, the potential difference ΔVhB may not be attenuated to a degree with which the ink can be stably ejected in the unit period Tu in which the vibration of the meniscus by the micro-vibration pulse PB is continued, or may be amplified, and stable ejection of the ink cannot be ensured when the ink is ejected from the nozzle N by the micro-vibration pulse PB or the driving element E is driven by the ejection pulse PA after the driving element E is driven by the micro-vibration pulse PB.

Further, in the present embodiment, the control circuit 21 sets the potential difference ΔVhB based on a lower limit micro-vibration threshold value BUth, in addition to the potential difference ΔVhA of the ejection pulse PA and the upper limit micro-vibration threshold value BPth. The lower limit micro-vibration threshold value BUth is a lower limit value of the potential difference ΔVhB, which is a potential change width of the potential change waveform element included in the micro-vibration pulse PB with which the thickening of the ink can be eliminated. When the potential difference ΔVhB is less than the lower limit micro-vibration threshold value BUth, there is a possibility that the thickening of the ink in the nozzle N cannot be eliminated. When the thickening of the ink is not eliminated, an ejection velocity of the ink ejected from the nozzle N is lowered, and there is a possibility that the ink is not ejected from the nozzle N. When the ejection velocity of the ink is reduced or the ink is not ejected, a quality of an image formed at the medium PP is reduced. In the first embodiment, the head manufacturer stores the upper limit micro-vibration threshold value BPth and the lower limit micro-vibration threshold value BUth of the potential change waveform element included in the micro-vibration pulse PB that is the expansion element e1 and the contraction element e3 in the storage circuit 22.

The upper limit micro-vibration threshold value BPth and the lower limit micro-vibration threshold value BUth are set by one or both of the experience and the experiment of the head manufacturer. The upper limit micro-vibration threshold value BPth is, for example, 6.3 [V]. The lower limit micro-vibration threshold value BUth is, for example, 3.0 [V]. The upper limit micro-vibration threshold value BPth is an example of a “first upper limit threshold value”. The lower limit micro-vibration threshold value BUth is an example of a “first lower limit threshold value”. The upper limit micro-vibration threshold value BPth is more than the lower limit micro-vibration threshold value BUth. A method of adjusting the drive signal Com will be described with reference to FIG. 6.

### A7: Method of Adjusting Drive Signal Com

FIG. 6 is a flowchart illustrating an example of a method of adjusting the drive signal Com. The flowchart illustrated in FIG. 6 is executed when power of the liquid ejecting apparatus 100 is turned on or when an instruction from a user of the liquid ejecting apparatus 100 is received.

The control circuit 21 stores a value of the reference potential difference ΔVhA-S in the storage circuit 22 before a process in step S2. An aspect of storing the value of the reference potential difference ΔVhA-S includes the following two aspects. In a first aspect, the control circuit 21 acquires the value of the reference potential difference ΔVhA-S from the reference waveform information CI stored in the storage circuit 22, and stores the acquired value in the storage circuit 22. In the first aspect, the control circuit 21 corrects the candidate waveform information CI stored in the storage circuit 22 in the process in and after step S2. As a second aspect, a value of the reference potential difference ΔVhA-S preset in the storage circuit 22 is stored. Further, in the second aspect, the control circuit 21 corrects the candidate waveform information CI stored in the storage circuit 22 in the process in and after step S2. In FIG. 6, an aspect in which the value of the reference potential difference ΔVhA-S is stored will be described by using the second aspect.

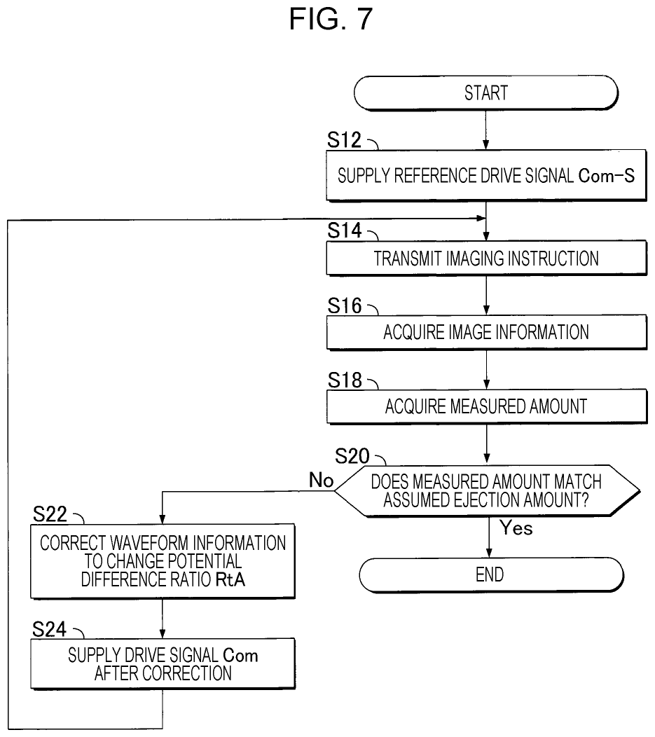

The control circuit 21 functions as the determination section 211, and executes a determination process of determining a waveform shape of the ejection pulse PA in step S2. Step S2 is an example of a “determination step”. The determination process will be described with reference to FIG. 7.

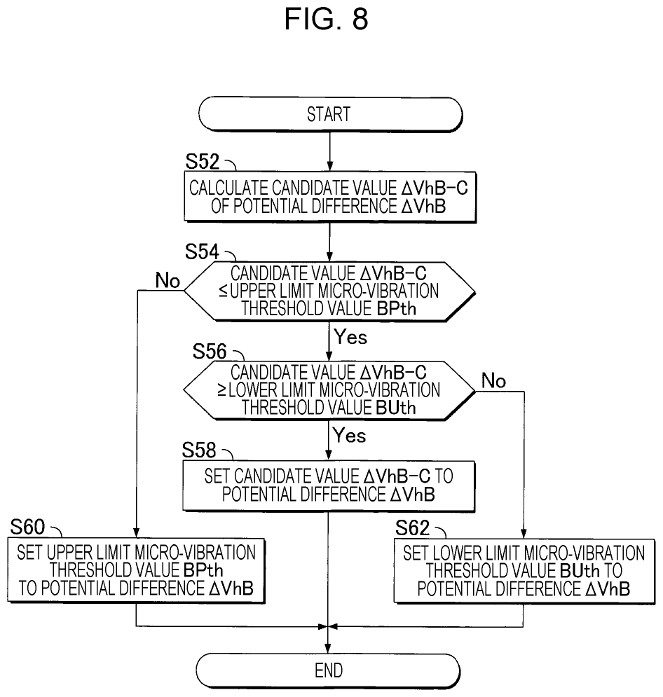

After the process in step S2 is ended, the control circuit 21 functions as the setting section 213 in step S4, and executes a setting process of setting the potential difference αVhB. Step S4 is an example of a “setting step”. The setting process will be described with reference to FIG. 8.

FIG. 7 is a flowchart illustrating an example of the determination process. The determination process is a process of determining a waveform shape of the ejection pulse PA such that the amount of ink ejected from the nozzle N when the ejection pulse PA is supplied to the driving element E is an assumed ejection amount.

In step S12, the control circuit 21 supplies the reference drive signal Com-S to the ejecting section D[m1] for any integer m1 from 1 to M. Specifically, the control circuit 21 generates the candidate waveform information CI for copying the reference waveform information CI, generates the waveform designation signal dCom based on the candidate waveform information CI indicating the reference drive signal Com-S, and outputs the generated waveform designation signal dCom to the drive signal generation circuit 24. Further, the control circuit 21 supplies the head chip 51 with the individual designation signal Sd[m1] indicating ink ejection.

The ejecting section D[m1] is an example of a “first ejecting section”. The nozzle N included in the ejecting section D[m1] is an example of a “first nozzle”, the pressure chamber C included in the ejecting section D[m1] is an example of a “first pressure chamber”, and the driving element E included in the ejecting section D[m1] is an example of a “first driving element”.

Further, in step S14, the control circuit 21 transmits the imaging instruction Sk3 to the imaging device 45 at a time at which the ink ejected from the ejecting section D[m1] can be imaged.

After the process in step S14 is ended, the control circuit 21 acquires the image information GI from the imaging device 45 in step S16. In step S18, the control circuit 21 analyzes the image information GI to acquire information indicating the ejection amount of the ink ejected from the ejecting section D[m1]. Hereinafter, the ink ejection amount indicated by the information acquired in step S18 may be referred to as a “measured amount”.

After the process in step S18 is ended, the control circuit 21 determines whether or not the measured amount matches the assumed ejection amount in step S20. The fact that the measured amount matches the assumed ejection amount means that the measured amount and the assumed ejection amount completely match with other, and means that a dot formed by the ink of the measured amount and a dot formed by the ink of the assumed ejection amount are considered to be the same when an error is considered.

When a determination result in step S20 is negative, the control circuit 21 changes a potential difference ratio RtA and corrects the candidate waveform information CI in step S22. The potential difference ratio RtA is a ratio of the potential difference ΔVhA to the reference potential difference ΔVhA-S. The potential difference ratio RtA is an example of a “first ratio”. When the measured amount is less than the assumed ejection amount, the control circuit 21 greatly changes the potential difference ratio RtA and corrects the candidate waveform information CI. On the other hand, when the measured amount is more than the assumed ejection amount, the control circuit 21 changes the potential difference ratio RtA to be less and corrects the candidate waveform information CI. Specifically, the candidate waveform information CI is generated in which a value obtained by multiplying the potential difference ratio RtA by a potential at an end tip of each waveform element of the drive signal Com included in the reference waveform information CI is set as a potential at an end tip of each element. Information indicating the end tip time of each waveform element of the candidate waveform information CI matches the reference waveform information CI.

After the process in step S22 is ended, in step S24, the control circuit 21 supplies the drive signal Com based on the corrected candidate waveform information CI to the ejecting section D[m1]. After the process in step S24 is ended, the control circuit 21 executes the process in step S14 again. When the determination result in step S20 is positive, the control circuit 21 ends a series of processes illustrated in FIG. 7 and executes the process in step S4 illustrated in FIG. 6.

FIG. 8 is a flowchart illustrating an example of the setting process in step S4 illustrated in FIG. 6. The setting process is a process of setting the potential difference αVhB based on the potential difference ΔVhA determined in the determination process, and the upper limit micro-vibration threshold value BPth and the lower limit micro-vibration threshold value BUth.

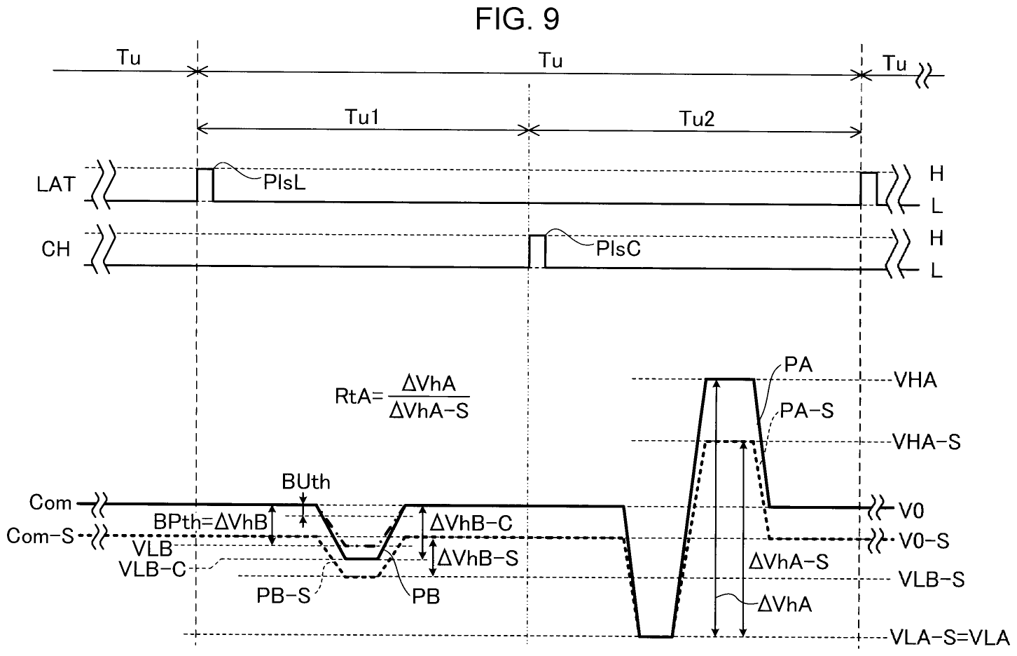

In step S52, the control circuit 21 calculates a candidate value ΔVhB-C of the potential difference ΔVhB based on the potential difference ratio RtA of the candidate waveform information CI at a final point of the determination process S2, that is, when the determination result is positive in step S20. Specifically, the control circuit 21 calculates the candidate value ΔVhB-C indicated by the candidate waveform information CI, which is a value obtained by multiplying the potential difference ratio RtA by the reference potential difference ΔVhB-S. The candidate value ΔVhB-C is an example of a “first candidate value”. An example of the candidate value ΔVhB-C will be described with reference to FIG. 9.

FIG. 9 is a diagram describing the candidate value ΔVhB-C. In FIG. 9, an element regarding the reference drive signal Com-S is added with “-S”. Further, in FIG. 9, the reference drive signal Com-S is indicated by a broken line, and the candidate drive signal Com indicated by the candidate waveform information CI after the process in step S20 is ended is indicated by a solid line. In step S22 of the determination process, the control circuit 21 generates the candidate waveform information CI from a value obtained by multiplying the potential difference ratio RtA by a potential of an end tip of each element of the reference drive signal Com-S, with reference to a potential of an end tip of the potential maintenance element pwh1 of the ejection waveform element DR included in the reference waveform signal CI, that is, the minimum potential VLA-S in the example in FIG. 9, which is the minimum potential of the reference drive signal Com-S. The potential used as the reference when the candidate waveform information CI is generated is not limited to the minimum potential VLA-S. For example, the control circuit 21 may generate the candidate waveform information CI with the reference potential V0-S as a reference, or may generate the candidate waveform information CI with the offset potential VBS as a reference. In the example in FIG. 9, an example in which the potential difference ratio RtA is more than 1 is illustrated.

As understood from the definition of the potential difference ratio RtA, a potential difference from the reference potential V0 to the minimum potential VLA, which is indicated by the candidate waveform information CI, is a value obtained by multiplying a potential difference from the reference potential V0-S to the minimum potential VLA, which is indicated by the reference waveform information CI, by the potential difference ratio RtA.

In FIG. 9, the candidate value ΔVhB-C is illustrated. In addition, the minimum potential VLB-C illustrated in FIG. 9 indicates an end tip potential of the expansion element e1 when the candidate value ΔVhB-C is set to the potential difference ΔVhB. A potential difference from the minimum potential VLB-C to the minimum potential VLA is a value obtained by multiplying the potential difference from the minimum potential VLB-S to the minimum potential VLA by the potential difference ratio RtA.

The description will be made with reference to FIG. 8. After the process in step S52 is ended, the control circuit 21 determines whether or not the candidate value ΔVhB-C is equal to or less than the upper limit micro-vibration threshold value BPth in step S54. When a determination result in step S54 is positive, in step S56, the control circuit 21 determines whether or not the candidate value ΔVhB-C is equal to or more than the lower limit micro-vibration threshold value BUth. When a determination result in step S56 is positive, the control circuit 21 sets the candidate value ΔVhB-C to the potential difference αVhB in step S58. The control circuit 21 sets the current candidate waveform information CI to be used as the waveform information CI to be used at a time of printing.

When the determination result in step S54 is negative, that is, when the candidate value ΔVhB-C exceeds the upper limit micro-vibration threshold value BPth, in step S60, the control circuit 21 sets the upper limit micro-vibration threshold value BPth to the potential difference ΔVhB, and sets the potential difference ΔVhB set between a potential of an end tip of the expansion element e1 and a potential of an end tip of the maintenance element e2 of the micro-vibration waveform element BE included in the candidate waveform information CI. Specifically, the control circuit 21 sets the end tip potential of the expansion element e1 of the candidate waveform information CI to a potential obtained by subtracting the upper limit micro-vibration threshold value BPth from the reference potential V0. Further, the control circuit 21 also sets the end tip potential of the maintenance element e2 of the candidate waveform information CI to a potential obtained by subtracting the upper limit micro-vibration threshold value BPth from the reference potential V0. The control circuit 21 sets the candidate waveform information CI to be used as the waveform information CI to be used at a time of printing.

When the determination result in step S56 is negative, that is, when the candidate value ΔVhB-C is less than the lower limit micro-vibration threshold value BUth, in step S62, the control circuit 21 sets the lower limit micro-vibration threshold value BUth to the potential difference αVhB, and sets the potential difference ΔVhB set between the potential of the end tip of the expansion element e1 and the potential of the end tip of the maintenance element e2 of the micro-vibration waveform element BE included in the candidate waveform information CI. Specifically, the control circuit 21 sets the end tip potential of the expansion element e1 of the candidate waveform information CI to a potential obtained by subtracting the lower limit micro-vibration threshold value BUth from the reference potential V0. Further, the control circuit 21 sets the end tip potential of the maintenance element e2 of the candidate waveform information CI to a potential obtained by subtracting the lower limit micro-vibration threshold value BUth from the reference potential V0. The control circuit 21 sets the candidate waveform information CI to be used as the waveform information CI to be used at a time of printing.

After the process in step S58 is ended, after the process in step S60 is ended, or after the process in step S62 is ended, the control circuit 21 ends a series of processes illustrated in FIG. 8 and further ends a series of processes illustrated in FIG. 6.

FIG. 9 illustrates a case where the candidate value ΔVhB-C exceeds the upper limit micro-vibration threshold value BPth. Since the candidate value ΔVhB-C exceeds the upper limit micro-vibration threshold value BPth, the control circuit 21 sets the upper limit micro-vibration threshold value BPth to the potential difference ΔVhB. In FIG. 9, a portion at which the potential is changed by setting the upper limit micro-vibration threshold value BPth to the potential difference ΔVhB in the drive signal Com is illustrated by a one-dot chain line. The minimum potential VLB illustrated in FIG. 9 is the end tip potential of the expansion element e1, and is a potential obtained by subtracting the potential difference ΔVhB from the reference potential V0.

### A8: Summary of First Embodiment

Hereinafter, a summary of the first embodiment will be described by using the ejecting section D[m1]. The disclosure content of the first embodiment can be defined as a driving method of a liquid ejecting apparatus. The liquid ejecting apparatus 100 includes the ejecting section D[m] having the nozzle N[m1] that ejects an ink onto the medium PP, the pressure chamber C[m1] that communicates with the nozzle N[m1], the driving element E[m1] that is driven to cause a pressure fluctuation in the ink in the pressure chamber C[m1] in accordance with the supplied drive signal Com, and the drive signal generation circuit 24 that generates the drive signal Com. The drive signal Com includes the ejection pulse PA having the ejection waveform element DR that changes in potential to cause the pressure fluctuation for ejecting the ink from the nozzle N[m1] in the ink in the pressure chamber C[m1], and the micro-vibration pulse PB having the micro-vibration waveform element BE that changes in potential to cause the pressure fluctuation without ejecting the ink from the nozzle N[m1] in the ink in the pressure chamber C[m1]. The driving method includes step S2 of determining the waveform shape of the ejection pulse PA, and step S4 of setting the potential difference αVhB in the micro-vibration waveform element BE based on the potential difference ΔVhA in the ejection waveform element DR determined in step S2 and the upper limit micro-vibration threshold value BPth.

According to the first embodiment, the excessive vibration of the ink in the nozzle N by the micro-vibration pulse PB and the unstable subsequent ejection of the ink from the nozzle by the ejection pulse PA can be suppressed, that is, the potential difference ΔVhB, which is an amplitude in the micro-vibration waveform element BE, can be appropriately set, as compared with an aspect in which the potential difference ΔVhB is set without using the upper limit micro-vibration threshold value BPth.

In step S2, the control circuit 21 determines the waveform shape of the ejection pulse PA such that the amount of ink ejected from the nozzle N [m1] when the ejection pulse PA is supplied to the driving element E [m1] is an assumed ejection amount. In step S4, the control circuit 21 calculates the candidate value ΔVhB-C, which is a candidate value for the potential difference ΔVhB in the micro-vibration waveform element BE, based on the potential difference ratio RtA, and sets the upper limit micro-vibration threshold value BPth to the potential difference ΔVhB when the candidate value ΔVhB-C exceeds the upper limit micro-vibration threshold value BPth.

According to the first embodiment, the unstable ink ejection can be suppressed while taking into account the manufacturing error of the ejecting section D[m1].

In step S4, when the candidate value ΔVhB-C is equal to or less than the upper limit micro-vibration threshold value BPth, the control circuit 21 sets the candidate value ΔVhB-C to the potential difference ΔVhB in the micro-vibration waveform element BE.

According to the first embodiment, a value in accordance with the manufacturing error of the ejecting section D[m1] can be set in the potential difference ΔVhB.

In step S4, when the candidate value ΔVhB-C is less than the lower limit micro-vibration threshold value BUth, the control circuit 21 sets the lower limit micro-vibration threshold value BUth to the potential difference ΔVhB.

According to the first embodiment, the thickening of the ink can be suppressed while taking into account the manufacturing error of the ejecting section D[m1]. By suppressing the thickening of the ink, the quality of the image formed at the medium PP can be maintained.

In addition, as understood from FIG. 9, when the candidate value ΔVhB-C is equal to or less than the upper limit micro-vibration threshold value BPth and is equal to or more than the lower limit micro-vibration threshold value BUth, the control circuit 21 sets the candidate value ΔVhB-C to the potential difference ΔVhB.

According to the first embodiment, the quality of the image formed at the medium PP can be maintained and the ejection stability can be achieved while taking into account the manufacturing error of the ejecting section D[m1].

### B: Second Embodiment

Since a viscosity of an ink varies depending on a temperature, it is considered that the upper limit micro-vibration threshold value BPth and the lower limit micro-vibration threshold value BUth are changed according to the temperature of the ink. Hereinafter, a second embodiment will be described.

### B1: Electrical Configuration of Liquid Ejecting Apparatus 100A According to Second Embodiment

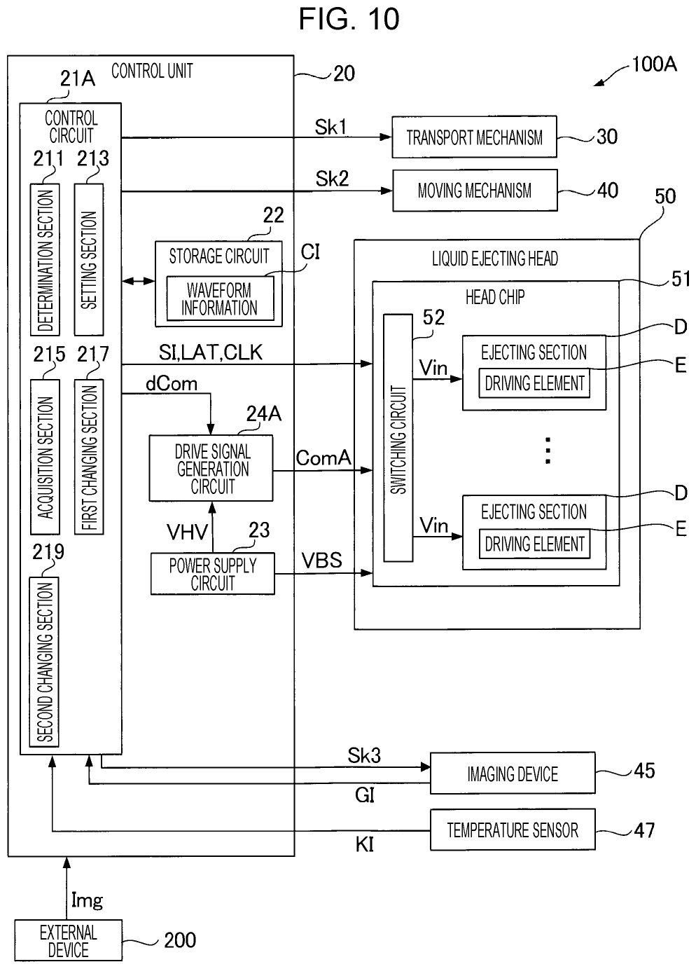

FIG. 10 is a diagram illustrating an electrical configuration of a liquid ejecting apparatus 100A. The liquid ejecting apparatus 100A is different from the liquid ejecting apparatus 100 in that the liquid ejecting apparatus 100A has a temperature sensor 47, has a control circuit 21A instead of the control circuit 21, and has a drive signal generation circuit 24A instead of the drive signal generation circuit 24.

The temperature sensor 47 measures a temperature of the liquid ejecting apparatus 100A as a temperature of an ink in the ejecting section D to generate temperature information KI indicating a measurement result. The temperature sensor 47 transmits the generated temperature information KI to the control circuit 21A. The temperature information KI is an example of “temperature information on a temperature of a liquid in the first ejecting section”.

In the second embodiment, a case is assumed in which the temperature sensor 47 is mounted on an electronic circuit on a substrate provided in the liquid ejecting apparatus 100A and detects the temperature of the liquid ejecting apparatus 100, but the present disclosure is not limited to such an aspect. For example, the temperature sensor 47 may be provided inside the liquid ejecting head 50 or may be provided inside the liquid container 10.

The control circuit 21A is different from the control circuit 21 in that the control circuit 21A reads a program stored in the storage circuit 22 and executes the read program to function as the determination section 211, the setting section 213, an acquisition section 215, a first changing section 217, and a second changing section 219. Further, the control circuit 21A is different from the control circuit 21 in that the control circuit 21A generates the control signal Sk1, the control signal Sk2, the printing data signal SI, the waveform designation signal dCom, the latch signal LAT, and the clock signal CLK.

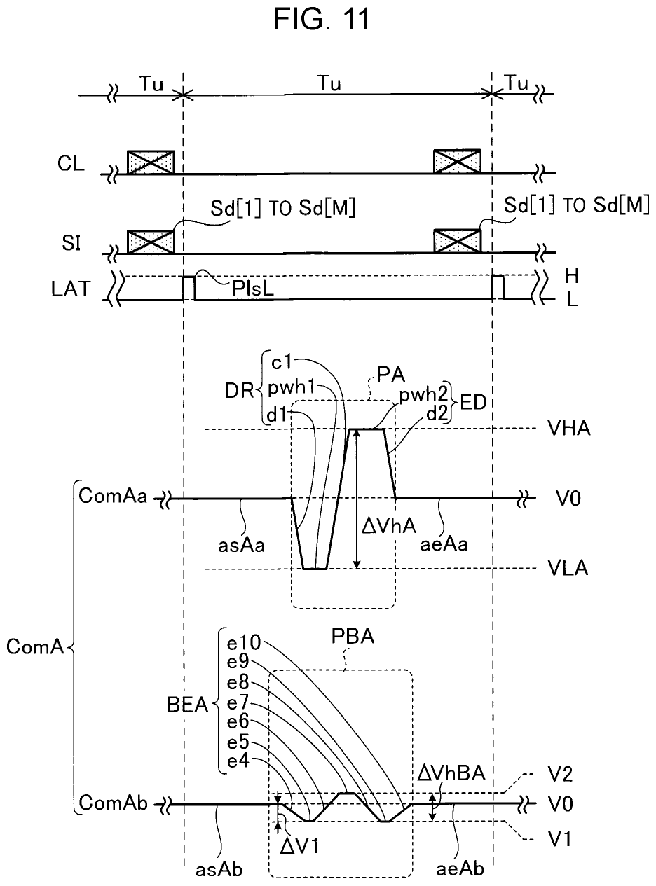

The drive signal generation circuit 24A is different from the drive signal generation circuit 24 in that a drive signal ComAa and a drive signal ComAb are generated. For example, the drive signal generation circuit 24A generates the drive signal ComAa and the drive signal ComAb by two independent circuits inside. Hereinafter, the drive signal ComAa and the drive signal ComAb may be referred to as a drive signal ComA without distinction. The drive signal ComA will be described with reference to FIG. 11.

### B2: Drive Signal ComA

FIG. 11 is a diagram describing the drive signal ComA. The drive signal ComAa has a start potential maintenance element asAa, the ejection pulse PA, and an end potential maintenance element aeAa in this order, in one unit period Tu. The drive signal ComAb has a start potential maintenance element asAb, a micro-vibration pulse PBA, and an end potential maintenance element aeAb in this order in one unit period Tu.

The start potential maintenance element asAa is an element that maintains the reference potential V0 from a start of one unit period Tu to a start of the ejection pulse PA. The end potential maintenance element aeAa is an element that maintains the reference potential V0 from an end of the ejection pulse PA to an end of one unit period Tu.

The start potential maintenance element asAb is an element that maintains the reference potential V0 from a start of one unit period Tu to a start of the micro-vibration pulse PBA. The end potential maintenance element aeAb is an element that maintains the reference potential V0 from an end of the micro-vibration pulse PBA to an end of one unit period Tu.

The micro-vibration pulse PBA has a micro-vibration waveform element BEA. The micro-vibration waveform element BEA has an expansion element e4, a maintenance element e5, a contraction element e6, a maintenance element e7, an expansion element e8, a maintenance element e9, and a contraction element e10 in this order. The expansion element e4 changes in potential from the reference potential V0 to the minimum potential V1. The minimum potential V1 is the minimum potential in the micro-vibration pulse PBA. The maintenance element e5 maintains the minimum potential V1. The contraction element e6 changes in potential from the minimum potential V1 to the maximum potential V2. The maximum potential V2 is the maximum potential in the micro-vibration pulse PBA. The maintenance element e7 maintains the maximum potential V2. The expansion element e8 changes in potential from the maximum potential V2 to the minimum potential V1. The maintenance element e9 maintains the minimum potential V1. The contraction element e10 is an element that returns from the minimum potential V1 to the reference potential V0.

In the second embodiment, the drive signal ComA is an example of the “first drive signal”. The drive signal generation circuit 24A is an example of the “first drive signal generation circuit”. The ejection pulse PA included in the drive signal ComAa is an example of the “first ejection pulse”, and the micro-vibration pulse PBA included in the drive signal ComAb is an example of the “first micro-vibration pulse”. The ejection waveform element DR included in the ejection pulse PA is an example of a “first ejection waveform element”. The micro-vibration waveform element BEA included in the micro-vibration pulse PBA is an example of the “first micro-vibration waveform element”.

As understood from FIG. 11, in the second embodiment, the drive signal ComAa having the ejection pulse PA and the drive signal ComAb having the micro-vibration pulse PBA are separated into separate drive signals and are the drive signal ComA that are generated in parallel in time within the unit period Tu, but the present disclosure is not limited thereto. For example, in the same manner as in the first embodiment, the ejection pulse PA and the micro-vibration pulse PBA may be configured to be sequentially arranged in time series within the unit period Tu of the same drive signal ComA.

### B3: Method of Adjusting Drive Signal ComA

In the second embodiment, the control circuit 21A sets any period in the micro-vibration pulse PBA, that is, the potential difference ΔV1, which is a potential change width for a period of the expansion element e4 in the second embodiment, based on the potential difference ΔVhA of the ejection pulse PA, an upper limit micro-vibration threshold value BP1th, and a lower limit micro-vibration threshold value BU1th. In the same manner, the control circuit 21 sets the potential difference ΔVhBA, which is a potential change width for a period of the contraction element e6 in the micro-vibration pulse PBA, based on the potential difference ΔVhA, an upper limit micro-vibration threshold value BP2th, and a lower limit micro-vibration threshold value BU2th. The potential difference ΔVhBA matches the maximum potential change width in the micro-vibration pulse PBA.

In the second embodiment, when correcting the potential change width for the period of the expansion element e4, the control circuit 21A changes an end tip potential of the expansion element e4. Further, the control circuit 21A sets a potential identical to the end tip potential of the expansion element e4 to an end tip potential of the maintenance element e5, an end tip potential of the expansion element e8, and an end tip potential of the maintenance element e9. Further, when correcting the potential change width for a period of the contraction element e6, the control circuit 21A changes an end tip potential of the contraction element e6. Further, the control circuit 21A sets a potential identical to the end tip potential of the contraction element e6 to an end tip potential of the maintenance element e7.

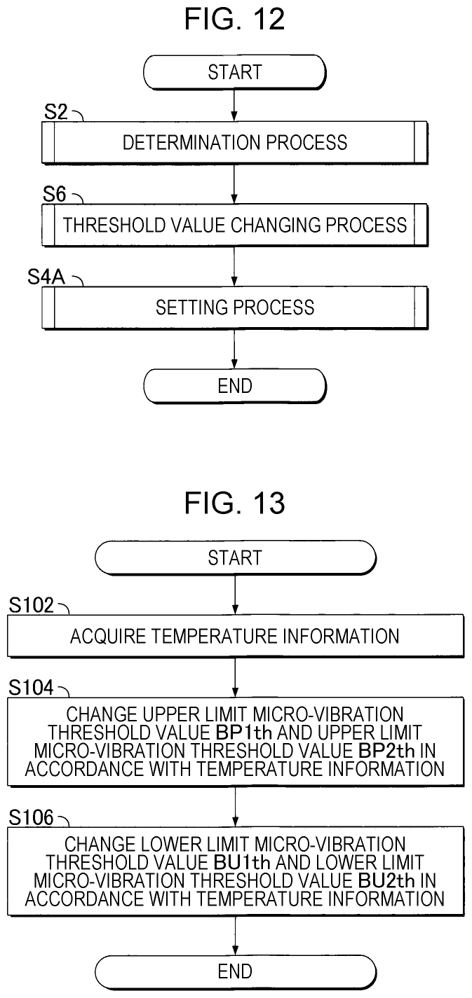

When the expansion element e4 and the contraction element e10 correspond to the “potential change waveform element”, the upper limit micro-vibration threshold value BP1th corresponds to the “first upper limit threshold value”, and the lower limit micro-vibration threshold value BU1th corresponds to the “first lower limit threshold value”. In addition, when the contraction element e6 and the expansion element e8 correspond to the “potential change waveform element”, the upper limit micro-vibration threshold value BP2th corresponds to the “first upper limit threshold value”, and the lower limit micro-vibration threshold value BU2th corresponds to the “first lower limit threshold value”. Hereinafter, a method of adjusting the drive signal ComA will be described with reference to FIG. 12.

FIG. 12 is a flowchart illustrating an example of a method of adjusting the drive signal ComA. The flowchart illustrated in FIG. 12 is different from the flowchart illustrated in FIG. 6 in that step S4A is executed instead in step S4 and a process in step S6 is executed between the process in step S2 and the process in step S4A, and is the same as the flowchart illustrated in FIG. 6 in other points. Hereinafter, only differences from the flowchart illustrated in FIG. 6 will be described. In step S2 of the second embodiment, the reference waveform information CI includes reference waveform information CIa corresponding to the drive signal ComAa and reference waveform information CIb corresponding to the drive signal ComAb. In addition, the candidate waveform information CI includes the candidate waveform information CIa corresponding to the drive signal ComAa and the candidate waveform information CIb corresponding to the drive signal ComAb.

After the process in step S2 is ended, the control circuit 21A executes a threshold value changing process in step S6. The process in step S6 may be executed before the process in step S2. The threshold value changing process will be described with reference to FIG. 13.

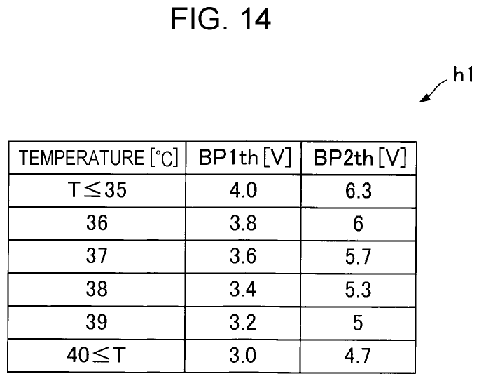

FIG. 13 is a flowchart illustrating an example of the threshold value changing process. The control circuit 21A functions as the acquisition section 215 in step S102 to acquire the temperature information KI from the temperature sensor 47. Next, in step S104, the control circuit 21A functions as the first changing section 217, and changes the upper limit micro-vibration threshold value BP1th and the upper limit micro-vibration threshold value BP2th in accordance with the temperature information KI. A specific modification example of the upper limit micro-vibration threshold value BP1th and the upper limit micro-vibration threshold value BP2th will be described with reference to FIG. 14. Step S102 is an example of an “acquisition step”. Step S104 is an example of a “first changing step”.

FIG. 14 is a diagram describing a modification example of the upper limit micro-vibration threshold value BP1th and the upper limit micro-vibration threshold value BP2th. The storage circuit 22 stores a table h1 illustrated in FIG. 14. The table h1 is information in which the upper limit micro-vibration threshold value BP1th and the upper limit micro-vibration threshold value BP2th are associated with each temperature. More specifically, the table h1 illustrates the upper limit micro-vibration threshold value BP1th and the upper limit micro-vibration threshold value BP2th corresponding to each of when the temperature information KI is 35 degrees Celsius or lower, when the temperature information KI is 36 degrees Celsius, when the temperature information KI is 37 degrees Celsius, when the temperature information KI is 38 degrees Celsius, when the temperature information KI is 39 degrees Celsius, and when the temperature information KI is 40 degrees Celsius or higher.

The description will be made with reference to FIG. 13. After the process in step S104 is ended, in step S106, the control circuit 21A functions as the second changing section 219 and changes the lower limit micro-vibration threshold value BU1th and the lower limit micro-vibration threshold value BU2th in accordance with the temperature information KI. Step S106 is an example of a “second changing step”. Since a method of changing the lower limit micro-vibration threshold value BU1th and the lower limit micro-vibration threshold value BU2th is the same as the method of changing the upper limit micro-vibration threshold value BP1th and the upper limit micro-vibration threshold value BP2th, except that the table referred to is different, the description will not be repeated. After the process in step S106 is ended, the control circuit 21A ends a series of processes illustrated in FIG. 13.

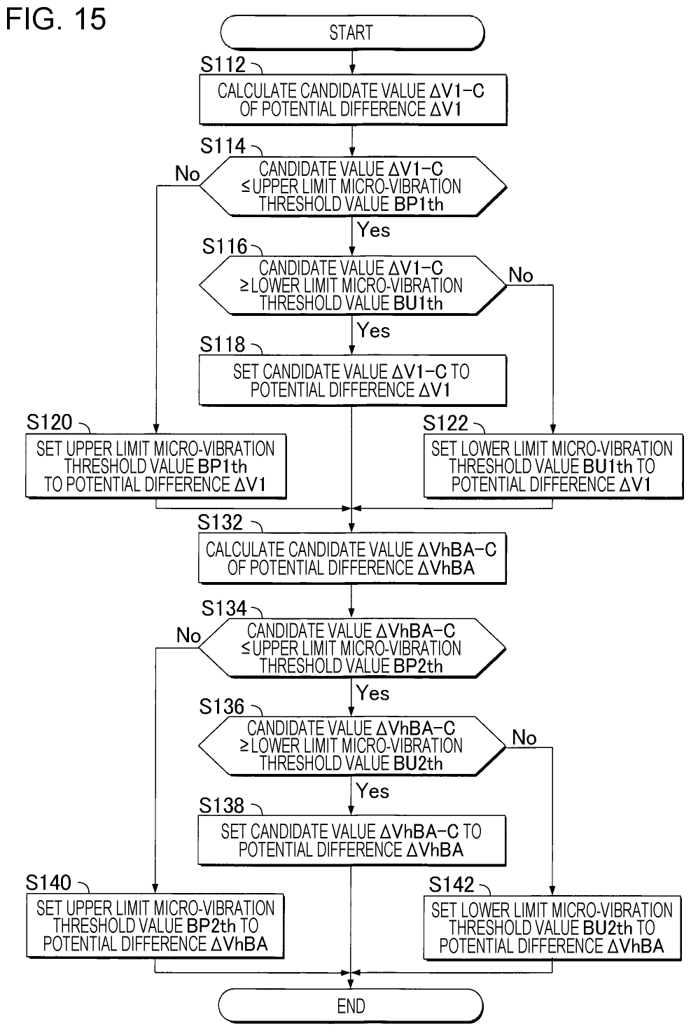

The description will be made with reference to FIG. 12. After step S6 is ended, the control circuit 21A executes a setting process in the second embodiment. The setting process in the second embodiment will be described with reference to FIG. 15.

FIG. 15 is a flowchart illustrating an example of the setting process in the second embodiment. Processes from step S112 to step S122 illustrated in FIG. 15 are the same as a process in which the potential difference ΔVhB is replaced with the potential difference ΔV1, the candidate value ΔVhB-C is replaced with a candidate value ΔV1-C, the upper limit micro-vibration threshold value BPth is replaced with the upper limit micro-vibration threshold value BP1th, and the lower limit micro-vibration threshold value BUth is replaced with the lower limit micro-vibration threshold value BU1th in the processes from step S52 to step S62 illustrated in FIG. 8. Therefore, the description will not be repeated. In S112 of the second embodiment, a value obtained by multiplying the potential difference ratio RtA corresponding to the candidate waveform information CIa at a final point of the determination process S2, that is, when the determination result is positive in step S20 by each end tip potential of each element included in the drive signal Com included in the reference waveform information CIb is set as an end tip potential of each element of the candidate waveform information CIb. Information indicating an end tip time of each waveform element of the candidate waveform information CIb matches the reference waveform information CIb. Further, the processes from step S132 to step S142 illustrated in FIG. 15 is the same as a process in which the potential difference ΔVhB is replaced with the potential difference ΔVhBA, the candidate value ΔVhB-C is replaced with the candidate value ΔVhBA-C, the upper limit micro-vibration threshold value BPth is replaced with the upper limit micro-vibration threshold value BP2th, and the lower limit micro-vibration threshold value BUth is replaced with the lower limit micro-vibration threshold value BU2th. Therefore, the description will not be repeated.

As a specific example of the process in step S120, the control circuit 21A sets the end tip potential of the expansion element e4, the end tip potential of the maintenance element e5, the end tip potential of the expansion element e8, and the end tip potential of the maintenance element e9 of the candidate waveform information CIb to a potential obtained by subtracting the upper limit micro-vibration threshold value BP1th from the reference potential V0. In the same manner, as a specific example of the process in step S122, the control circuit 21A sets the end tip potential of the expansion element e4, the end tip potential of the maintenance element e5, the end tip potential of the expansion element e8, and the end tip potential of the maintenance element e9 of the candidate waveform information CIb to a potential obtained by subtracting the lower limit micro-vibration threshold value BU1th from the reference potential V0.

As a specific example of the process in step S140, the control circuit 21A sets the end tip potential of the contraction element e6 of the candidate waveform information CIb and the end tip potential of the maintenance element e7 to a potential obtained by adding the upper limit micro-vibration threshold value BP2th to the end tip potential of the expansion element e4. In the same manner, as a specific example of the process in step S142, the control circuit 21A sets the end tip potential of the contraction element e6 of the candidate waveform information CIb and the end tip potential of the maintenance element e7 to a potential obtained by adding the lower limit micro-vibration threshold value BU2th to the end tip potential of the expansion element e4.

The potential change waveform elements included in the micro-vibration pulse PBA are the expansion element e4, the contraction element e6, the expansion element e8, and the contraction element e10, and when the potential change waveform elements that adjust the potential change width are the expansion element e4 and the contraction element e10, the candidate value ΔV1-C corresponds to the “first candidate value”. In addition, when the potential change waveform elements for adjusting the potential change width is the contraction element e6 and the expansion element e8, the candidate value ΔVhBA-C corresponds to the “first candidate value”.

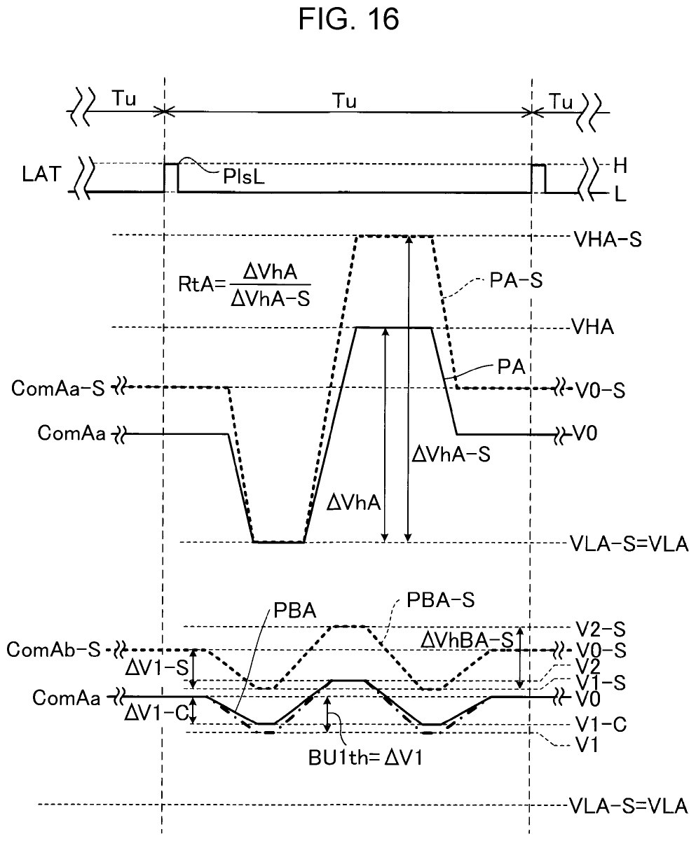

FIG. 16 is a diagram describing an example of an adjustment result of the drive signal ComA. In FIG. 16, elements related to a reference drive signal ComAa-S and a reference drive signal ComAb-S are added with “-S”. Further, in FIG. 16, the reference drive signal ComAa-S and the reference drive signal ComAb-S are illustrated by broken lines, and the drive signal ComA indicated by the candidate waveform information CI after the end of the determination process S2 is illustrated by a solid line. In the example in FIG. 16, the potential difference ratio RtA is illustrated as being less than 1.

As understood from the definition of the potential difference ratio RtA, a potential difference from the reference potential V0 to the minimum potential VLA, which is indicated by the candidate waveform information CI, is a value obtained by multiplying a potential difference from the reference potential V0-S to the minimum potential VLA, which is indicated by the reference waveform information CI, by the potential difference ratio RtA.

In FIG. 16, the candidate value ΔV1-C is illustrated. In step S112, the control circuit 21A calculates a value obtained by multiplying the potential difference ratio RtA by a reference potential difference ΔV1-S as the candidate value ΔV1-C. In addition, the minimum 104 potential V1-C illustrated in FIG. 16 indicates an end tip potential of the expansion element e4 when the candidate value ΔV1-C is set to the potential difference ΔV1.

FIG. 16 illustrates a case where the candidate value ΔV1-C is less than the lower limit micro-vibration threshold value BU1th. Since the candidate value ΔV1-C is less than the lower limit micro-vibration threshold value BU1th, the control circuit 21A sets the lower limit micro-vibration threshold value BU1th to the potential difference ΔV1. In FIG. 16, a portion at which the potential is changed by setting the lower limit micro-vibration threshold value BU1th to the potential difference ΔV1 in the drive signal Com is indicated by a one-dot chain line. The minimum potential V1 illustrated in FIG. 16 is the end tip potential of the expansion element e4, and is a potential obtained by subtracting the potential difference ΔV1 from the reference potential V0. The control circuit 21A sets the end tip potential of the expansion element e4, an end tip potential of the maintenance element e5, an end tip potential of the expansion element e8, and an end tip potential of the maintenance element e9 of the micro-vibration waveform element BEA included in the candidate waveform information CIb to the minimum potential V1.

### B4: Summary of Second Embodiment

Hereinafter, in an example in which the expansion element e4 and the contraction element e10 correspond to the “potential change waveform element”, the upper limit micro-vibration threshold value BP1th corresponds to the “first upper limit threshold value”, the lower limit micro-vibration threshold value BU1th corresponds to the “first lower limit threshold value”, and the candidate value ΔV1-C corresponds to the “first candidate value”, the second embodiment will be described in summary by using the ejecting section D[m1] which is any integer m1 of 1 to M. The disclosure content of the second embodiment can be defined as a driving method of a liquid ejecting apparatus. The driving method further includes step S102 of acquiring the temperature information KI on a temperature of an ink in the ejecting section D[m1], and step S104 of changing the upper limit micro-vibration threshold value BP1th in accordance with the temperature information KI. In step S4A, when the candidate value ΔV1-C exceeds the upper limit micro-vibration threshold value BP1th changed in step S104, the control circuit 21A sets the upper limit micro-vibration threshold value BP1th to the potential difference ΔV1 in the micro-vibration waveform element BEA.

According to the second embodiment, even when the temperature of the ink changes, the unstable ink ejection can be suppressed while taking into account the manufacturing error of the ejecting section D[m1].

The driving method further includes step S102 described above and step S106 of changing the lower limit micro-vibration threshold value BU1th in accordance with the temperature information KI. In step S4A, when the candidate value ΔV1-C is less than the lower limit micro-vibration threshold value BU1th changed in step S106, the control circuit 21A sets the lower limit micro-vibration threshold value BU1th to the potential difference ΔV1 in the micro-vibration waveform element BEA.

According to the second embodiment, even when the temperature of the ink changes, the thickening of the ink can be suppressed while taking into account the manufacturing error of the ejecting section D[m1].

In step S4A, when the candidate value ΔV1-C is equal to or less than the upper limit micro-vibration threshold value BP1th and is equal to or more than the lower limit micro-vibration threshold value BU1th, the control circuit 21A sets the candidate value ΔV1-C as the potential difference ΔV1.

According to the second embodiment, the quality of the image formed at the medium PP can be maintained and the ejection stability can be achieved while taking into account the manufacturing error of the ejecting section D[m1].

### C: Modification Example

Each form exemplified above can be variously modified. Specific modification aspects that can be applied to each embodiment described above will be described below. Any two or more aspects selected from the following examples can be combined as appropriate as long as there is no contradiction.

### C1: First Modification Example

In each of the embodiments described above, the liquid ejecting apparatus 100 has one head chip 51, but may have two or more head chips 51. Hereinafter, a first modification example will be described.

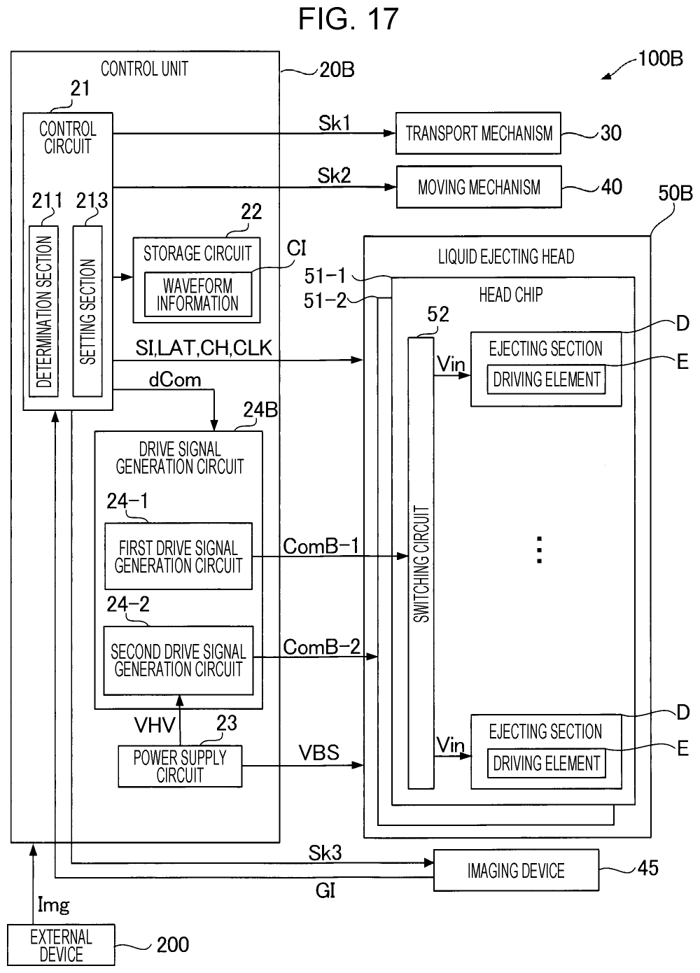

FIG. 17 is a diagram illustrating an electrical configuration of a liquid ejecting apparatus 100B according to the first modification example. The liquid ejecting apparatus 100B is different from the liquid ejecting apparatus 100 in that a control unit 20B is provided instead of the control unit 20, and a liquid ejecting head 50B is provided instead of the liquid ejecting head 50.

The control unit 20B is different from the control unit 20 in that the control unit 20B includes a drive signal generation circuit 24B instead of the drive signal generation circuit 24. The drive signal generation circuit 24B is different from the drive signal generation circuit 24 in that the drive signal generation circuit 24B includes a drive signal generation circuit 24-1 and a drive signal generation circuit 24-2. The liquid ejecting head 50B is different from the liquid ejecting head 50 in that the liquid ejecting head 50B has a head chip 51-1 and a head chip 51-2 instead of the head chip 51.

The drive signal generation circuit 24-1 generates a drive signal ComB-1. The drive signal ComB-1 is supplied to the head chip 51-1. The drive signal generation circuit 24-2 generates a drive signal ComB-2. The drive signal ComB-2 is supplied to the head chip 51-2. In the following description, the drive signal ComB-1 and the drive signal ComB-2 may be referred to as a drive signal ComB without distinction.

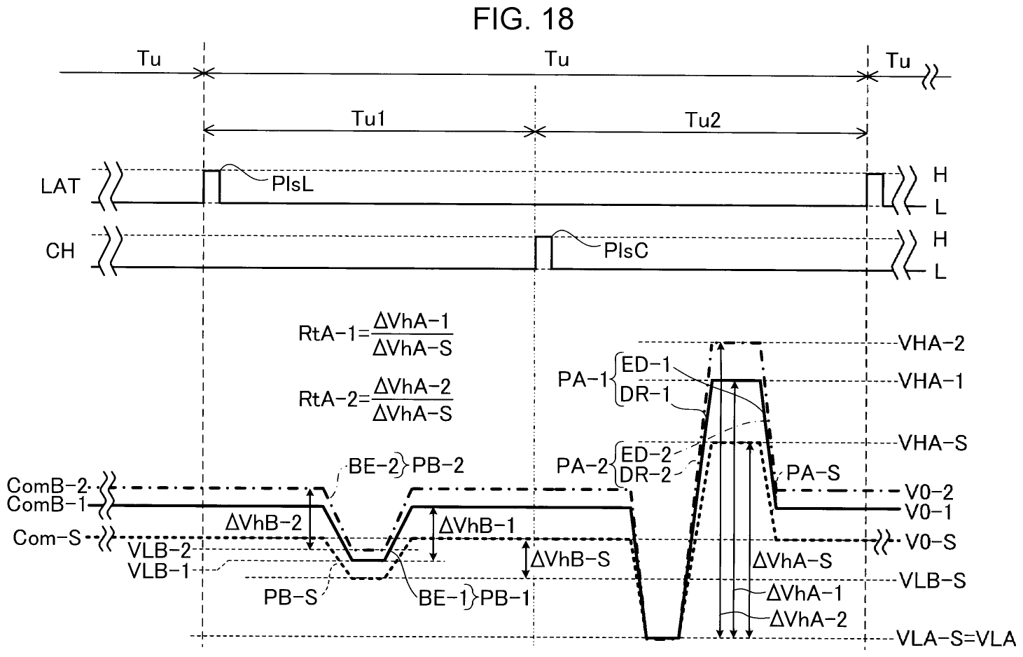

As described above, a manufacturing error may occur in the head chip 51. Therefore, the control circuit 21 executes the series of processes illustrated in FIG. 6 for each of the drive signal ComB-1 and the drive signal ComB-2. Before executing the series of processes illustrated in FIG. 6, the control circuit 21 stores a value of the reference potential difference ΔVhA-S in the storage circuit 22, in the same manner as in the first embodiment. In the first modification example, candidate waveform information CIB-1 corresponding to the drive signal ComB-1 and candidate waveform information CIB-2 corresponding to the drive signal ComB-2 are generated from reference waveform information CIB stored in the storage circuit 22. The control circuit 21 corrects the first candidate waveform information CIB-1 in adjusting the drive signal ComB-1, and corrects the second candidate waveform information CIB-2 in adjusting the drive signal ComB-2. Hereinafter, a case where the drive signal ComB-1 is supplied to the ejecting section D[m1] of the head chip 51-1 to adjust the drive signal ComB-1 for any integer m1 from 1 to M, and the drive signal ComB-2 is supplied to the ejecting section D[m2] of the head chip 51-2 to adjust the drive signal ComB-2 for any integer m2 from 1 to M will be described with reference to FIG. 18.

When the process in step S22 is executed on the drive signal ComB-1, the control circuit 21 changes a potential difference ratio RtA-1 to correct the first candidate waveform information CIB-1. The potential difference ratio RtA-1 is a ratio of a potential difference ΔVhA-1 to the reference potential difference ΔVhA-S. In the same manner, when the process in step S22 is executed on the drive signal ComB-2, the control circuit 21 changes a potential difference ratio RtA-2 to correct the second candidate waveform information CIB-2. The potential difference ratio RtA-2 is a ratio of a potential difference ΔVhA-2 to the reference potential difference ΔVhA-S. In the first modification example, the potential difference ratio RtA-1 is an example of the “first ratio”, and the potential difference ratio RtA-2 is an example of a “second ratio”.

Further, when the process in step S52 is executed on the drive signal ComB-1, the control circuit 21 calculates a candidate value ΔVhB-1C of a potential difference αVhB-1 based on the potential difference ratio RtA-1. In the same manner, when the process in step S52 is executed on the drive signal ComB-2, the control circuit 21 calculates a candidate value ΔVhB-2C of a potential difference αVhB-2 based on the potential difference ratio RtA-2. In the first modification example, the candidate value ΔVhB-C of the potential difference ΔVhB-1 is an example of the “first candidate value”, and the candidate value ΔVhB-C of the potential difference ΔVhB-2 is an example of a “second candidate value”.

FIG. 18 is a diagram describing an example of an adjustment result of the drive signal ComB. In FIG. 18, an element regarding the reference drive signal Com-S is added with “-S”. In the same manner, the element regarding the drive signal ComB-1 is added with “-1”, and the element regarding the drive signal ComB-2 is added with “-2”. Further, in FIG. 18, the reference drive signal Com-S is indicated by a broken line, the drive signal ComB-1 is indicated by a solid line, and the drive signal ComB-2 is indicated by a one-dot chain line.

FIG. 18 illustrates an example in which the potential difference ΔVhA-2 is more than the potential difference ΔVhA-1, and the potential difference ΔVhA-1 is more than the reference potential difference ΔVhA-S. Further, in FIG. 18, an example is illustrated in which, as a result of adjusting the drive signal ComB, the potential difference αVhB-2 is more than the potential difference ΔVhB-1, and the potential difference ΔVhB-1 is more than the reference potential difference ΔVhB-S.

In the example illustrated in FIG. 18, when the potential difference ratio RtA-1 and the potential difference ratio RtA-2 are different, the potential difference ΔVhA-1 and the potential difference ΔVhA-2 are different, and the candidate value ΔVhB-1C and the candidate value ΔVhB-2C calculated in step S52 are different. Meanwhile, when the potential difference ΔVhA-1 and the potential difference ΔVhA-2 are different, the potential difference αVhB-1 and the potential difference ΔVhB-2 are not necessarily different. For example, when both the candidate value ΔVhB-1C of the potential difference ΔVhB-1 and the candidate value ΔVhB-2C of the potential difference ΔVhB-2 exceed the upper limit micro-vibration threshold value BPth, the potential difference ΔVhB-1 and the potential difference ΔVhB-2 match the upper limit micro-vibration threshold value BPth. In addition, when both the candidate value ΔVhB-1C of the potential difference ΔVhB-1 and the candidate value ΔVhB-2C of the potential difference ΔVhB-2 are less than the lower limit micro-vibration threshold value BUth, the potential difference ΔVhB-1 and the potential difference ΔVhB-2 match the lower limit micro-vibration threshold value BUth. When at least one of the value of the candidate value ΔVhB-1C and the value of the candidate value ΔVhB-2C is the value of the upper limit micro-vibration threshold value BPth and the lower limit micro-vibration threshold value BUth, the potential difference ΔVhB-1 and the potential difference ΔVhB-2 are different.

In the first modification example, the drive signal ComB-1 is an example of the “first drive signal”. The drive signal generation circuit 24-1 is an example of the “first drive signal generation circuit”. The ejection pulse PA-1 included in the drive signal ComB-1 is an example of the “first ejection pulse”, and the micro-vibration pulse PB-1 included in the drive signal ComB-1 is an example of the “first micro-vibration pulse”. The ejection waveform element DR-1 included in the ejection pulse PA-1 is an example of the “first ejection waveform element”. The micro-vibration waveform element BE-1 included in the micro-vibration pulse PB-1 is an example of the “first micro-vibration waveform element”. The ejecting section D[m1] of the head chip 51-1 is an example of the “first ejecting section”.

In addition, in the first modification example, the drive signal ComB-2 is an example of a “second drive signal”. The drive signal generation circuit 24-2 is an example of a “second drive signal generation circuit”. The ejection pulse PA-2 included in the drive signal ComB-2 is an example of a “second ejection pulse”, and the micro-vibration pulse PB-2 included in the drive signal ComB-2 is an example of a “second micro-vibration pulse”. The ejection waveform element DR-2 included in the ejection pulse PA-2 is an example of a “second ejection waveform element”. The micro-vibration waveform element BE-2 included in the micro-vibration pulse PB-2 is an example of a “second micro-vibration waveform element”. The ejecting section D[m2] of the head chip 51-2 is an example of a “second ejecting section”. The nozzle N included in the ejecting section D[m2] of the head chip 51-2 is an example of a “second nozzle”, the pressure chamber C included in the ejecting section D[m2] is an example of a “second pressure chamber”, and the driving element E included in the ejecting section D[m2] is an example of a “second driving element”.

The summary of the first modification example will be described above by using the ejecting section D[m1] of the head chip 51-1 and the ejecting section D[m2] of the head chip 51-2. The liquid ejecting apparatus 100B further includes the ejecting section D[m2] having the nozzle N[m2] that ejects an ink onto the medium PP, the pressure chamber C[m2] that communicates with the nozzle N[m2], the driving element E[m2] that is driven to cause a pressure fluctuation in the ink in the pressure chamber C[m2] in accordance with the supplied drive signal ComB-2, and the drive signal generation circuit 24-2 that generates the drive signal ComB-2. The drive signal ComB-2 includes the ejection pulse PA-2 having the ejection waveform element DR-2 that changes in potential to cause pressure fluctuation for ejecting the ink from the nozzle N[m2] in the ink in the pressure chamber C[m2], and the micro-vibration pulse PB-2 having the micro-vibration waveform element BE-2 that changes in potential to cause the pressure fluctuation without ejecting the ink from the nozzle N[m2] in the ink in the pressure chamber C[m2]. In step S2, the control circuit 21 determines a waveform shape of the ejection pulse PA-2 such that the amount of ink ejected from the nozzle N [m2] when the ejection pulse PA-2 is supplied to the driving element E [m2] is an assumed ejection amount. In step S4, the control circuit 21 calculates the candidate value ΔVhB-2C, which is a candidate value for the potential difference ΔVhB-2 in the micro-vibration waveform element BE-2, based on the potential difference ratio RtA-2. When the candidate value ΔVhB-2C of the potential difference ΔVhB-2 exceeds the upper limit micro-vibration threshold value BPth, the control circuit 21 sets the upper limit micro-vibration threshold value BPth to the potential difference ΔVhB-2 of the micro-vibration pulse PB-2. Further, when the candidate value ΔVhB-2C is less than the lower limit micro-vibration threshold value BUth, the control circuit 21 sets the lower limit micro-vibration threshold value BUth to the potential difference ΔVhB-2. When the potential difference ΔVhA-1 in the ejection waveform element DR-1 and the potential difference ΔVhA-2 in the ejection waveform element DR-2 are different, the potential difference ΔVhB-1 of the micro-vibration pulse PB-1 and the potential difference ΔVhB-2 in the micro-vibration pulse PB-2 are different, the potential difference ΔVhB-1 and the potential difference ΔVhB-2 match the upper limit micro-vibration threshold value BPth, or the potential difference ΔVhB-1 and the potential difference ΔVhB-2 match the lower limit micro-vibration threshold value BUth.

As described above, according to the first modification example, an amplitude in the micro-vibration waveform element BE can be appropriately set for each of the ejecting section D[m1] and the ejecting section D[m2] in which the manufacturing errors are different from each other.

### C2: Second Modification Example

In each of the above aspects, the upper limit micro-vibration threshold value BPth and the lower limit micro-vibration threshold value BUth are used for the micro-vibration pulse PB. Meanwhile, an upper limit threshold value and a lower limit threshold value may be used for the ejection pulse PA. Hereinafter, a second modification example will be described.

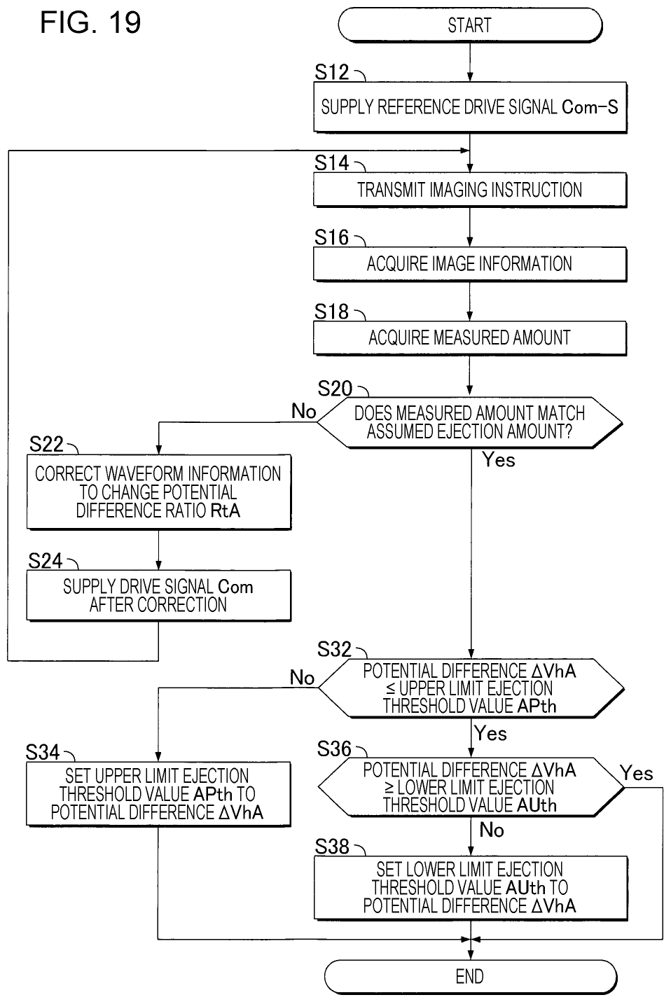

FIG. 19 is a flowchart illustrating an example of a determination process in the second modification example. The flowchart illustrated in FIG. 19 is the same as the flowchart illustrated in FIG. 7, except that a process is added when the determination result in step S20 is positive. Therefore, in the following, only the process when the determination result in step S20 is positive will be described. A waveform shape of the drive signal Com indicated by the candidate waveform information CI when the determination result in step S20 is positive is a candidate for a waveform shape of the ejection pulse PA and is an example of a “first shape”.

When the determination result in step S20 is positive, the control circuit 21 determines whether or not the potential difference ΔVhA is equal to or less than an upper limit ejection threshold value APth in step S32. The upper limit ejection threshold value APth is an upper limit value of the maximum potential change width in the ejection waveform element DR with which the ejection of an ink can be stabilized. When the potential difference ΔVhA exceeds the upper limit ejection threshold value APth, the stability of the ejection of the ink cannot be ensured in some cases. The upper limit ejection threshold value APth is an example of a “second upper limit threshold value”.

When the determination result in step S32 is negative, the control circuit 21 sets the upper limit ejection threshold value APth to the potential difference ΔVhA in step S34. Specifically, the control circuit 21 corrects the candidate waveform information CI such that a value obtained by adding the upper limit ejection threshold value APth to the minimum potential VLA becomes the maximum potential VHA. After the process in step S34 is ended, the control circuit 21 ends a series of processes illustrated in FIG. 19.

When the determination result in step S32 is positive, the control circuit 21 determines whether or not the potential difference ΔVhA is equal to or more than a lower limit ejection threshold value AUth in step S36. The lower limit ejection threshold value AUth is a lower limit value of the maximum potential change width in the ejection waveform element DR with which an ink can be ejected at a predetermined ejection velocity at which the ejected droplet can land at a predetermined position. When the potential difference ΔVhA is less than the lower limit ejection threshold value AUth, the ejection velocity of the ink may be decreased. The lower limit ejection threshold value AUth is an example of a “second lower limit threshold value”.

When the determination result in step S36 is positive, the control circuit 21 ends the series of processes illustrated in FIG. 19. When the determination result in step S36 is negative, the control circuit 21 sets the lower limit ejection threshold value AUth to the potential difference ΔVhA in step S38. Specifically, the control circuit 21 corrects the candidate waveform information CI such that a value obtained by adding the lower limit ejection threshold value AUth to the minimum potential VLS becomes the maximum potential VHA. After the process in step S38 is ended, the control circuit 21 ends the series of processes illustrated in FIG. 19.

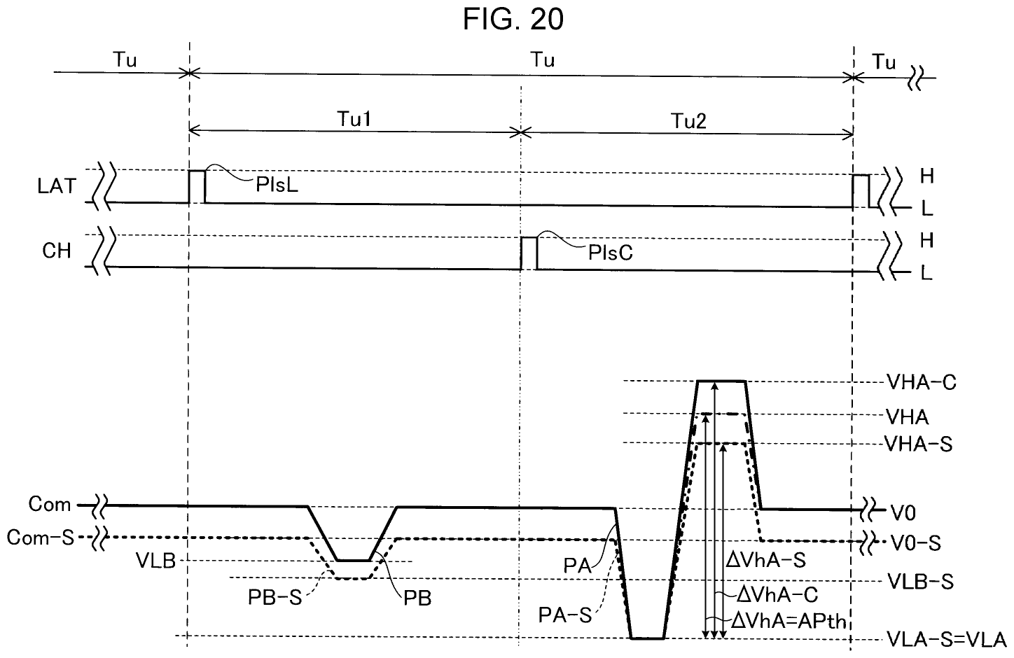

FIG. 20 is a diagram describing an example of an adjustment result of the drive signal Com in the second modification example. In FIG. 20, an element regarding the reference drive signal Com-S is added with “-S”. Further, in FIG. 20, the reference drive signal Com-S is indicated by a broken line, and the drive signal ComA indicated by the candidate waveform information CI after the determination result in step S20 in the determination process is positive is indicated by a solid line. In the example in FIG. 20, an example in which the potential difference ratio RtA is more than 1 is illustrated. Further, in FIG. 20, for easy understanding, the potential difference ΔVhA, which is the maximum potential change width of the ejection waveform element DR after the determination result in step S20 in the determination process is positive, is illustrated as a potential difference ΔVhA-C, and an end tip potential of the ejecting element c1 is illustrated as the maximum potential VHA-C.

FIG. 20 illustrates a case where the potential difference ΔVhA-C exceeds the upper limit ejection threshold value APth. Since the potential difference ΔVhA-C exceeds the upper limit ejection threshold value APth, the control circuit 21 sets the upper limit ejection threshold value APth to the potential difference ΔVhA. In FIG. 20, a portion at which the potential is changed by setting the upper limit ejection threshold value APth to the potential difference ΔVhA in the drive signal Com is illustrated by a one-dot chain line. The maximum potential VHA illustrated in FIG. 20 is an end tip potential of the ejecting element c1, and is a potential obtained by adding the upper limit ejection threshold value APth to the minimum potential VLA.

In the same manner as in the second embodiment, the control circuit 21 may change the upper limit ejection threshold value APth and the lower limit ejection threshold value AUth according to a temperature of an ink.

The summary of the second modification example will be described above by using the ejecting section D[m1]. In the processes from step S12 to step S20, the control circuit 21 sets the first shape, which is a candidate for the waveform shape of the ejection pulse PA, such that the amount of ink ejected from the nozzle N[m1] when the ejection pulse PA is supplied to the driving element E[m1] is an assumed ejection amount. In step S32 and step S34, when the potential difference ΔVhA, which is the maximum potential change width of the first shape ejection waveform element DR, exceeds the upper limit ejection threshold value APth, the control circuit 21 determines the waveform shape of the ejection pulse PA such that the potential difference ΔVhA in the ejection waveform element DR is the upper limit ejection threshold value APth.

According to the second modification example, supplying of the potential difference ΔVhA that causes the unstable ink ejection to the ejecting section D[m1] can be suppressed while taking into account a manufacturing error of the ejecting section D[m1].

In addition, in step S36 and step S38, when the potential difference ΔVhA of the ejection waveform element DR of the first shape is less than the lower limit ejection threshold value AUth, the waveform shape of the ejection pulse PA is determined such that the potential difference ΔVhA of the ejection waveform element DR is the lower limit ejection threshold value AUth.

According to the second modification example, supplying of the potential difference ΔVhA with which an ejection velocity of the ink is decreased and a landing deviation occurs to the ejecting section D[m1] can be suppressed while taking into account the manufacturing error of the ejecting section D[m1].

### C3: Third Modification Example

In each of the above aspects, when the determination result in step S54 is positive, the control circuit 21 may execute the process in step S58 without executing the process in step S56. In other words, a lower limit value of the potential difference ΔVhB may not be provided. In other words, the control circuit 21 may set the potential difference ΔVhA based on the potential difference ΔVhA of the ejection pulse PA and the upper limit micro-vibration threshold value BPth. Therefore, at least the ejection stability can be ensured.

For example, in the first modification example and the modification example of the first modification example, the control circuit 21 may not compare the candidate value ΔVhB-1C and the candidate value ΔVhB-2C with the lower limit micro-vibration threshold value BUth. In the modification example, when the potential difference ΔVIA-1 in the ejection waveform element DR-1 and the potential difference ΔVhA-2 in the ejection waveform element DR-2 are different from each other, the potential difference ΔVIA-1 in the micro-vibration pulse PB-1 and the potential difference ΔVhA-2 in the micro-vibration pulse PB-2 are different from each other, or the potential difference ΔVhB-1 and the potential difference ΔVhB-2 match the upper limit micro-vibration threshold value BPth.

### C4: Fourth Modification Example

In the second modification example and the modification example of the second modification example, the control circuit 21 may not execute the process in step S36 and the process in step S38 when the determination result in step S32 is positive, in the same manner as in the third modification example. In other words, a lower limit value of the potential difference ΔVhA may not be provided.

### C5: Fifth Modification Example

In the second embodiment and the modification example of the second embodiment, the control circuit 21A may execute the process in step S106 without executing the process in step S104 after the process in step S102 is ended. Alternatively, in the second embodiment and the modification example of the second embodiment, the control circuit 21A may not execute the process in step S106 after executing the process in step S104, and may end a series of processes illustrated in FIG. 13.

### C6: Sixth Modification Example

In the first embodiment and the first modification example, the ejection pulse PA and the micro-vibration pulse PB are sequentially arranged in time series within the unit period Tu of the same drive signal Com, but the present disclosure is not limited thereto, and the ejection pulse PA and the micro-vibration pulse PB may be divided into different drive signals and may be generated in parallel in time within the unit period Tu, in the same manner as in the second embodiment. In addition, in the second embodiment, the ejection pulse PA and the micro-vibration pulse PBA are separated into different drive signals and are generated in parallel in time within the unit period Tu. Meanwhile, the present disclosure is not limited to this, and the ejection pulse PA and the micro-vibration pulse PBA may be sequentially arranged in time series within the unit period Tu of the same drive signal Com in the same manner as in the first embodiment.

### C7: Seventh Modification Example

In the first embodiment and the first modification example, the micro-vibration waveform element BE of the micro-vibration pulse PB is a trapezoidal wave, but the present disclosure is not limited thereto. In the same manner as in the micro-vibration waveform element BEA of the micro-vibration pulse PBA of the second embodiment, a configuration in which a plurality of expansion elements and a plurality of contraction elements are included, or a configuration in which one of a plurality of expansion elements and a plurality of contraction elements are included may be provided. In addition, in the second embodiment, the micro-vibration waveform element BEA of the micro-vibration pulse PBA includes a configuration in which a plurality of expansion elements and a plurality of contraction elements are included, but the present disclosure is not limited to this, and may have a configuration in which the micro-vibration waveform element BEA of the micro-vibration pulse PBA includes each of one expansion element and one contraction element, or a configuration of a trapezoidal wave in which the micro-vibration waveform element BEA of the micro-vibration pulse PBA includes one of the expansion element and the contraction element.

### C8: Eighth Modification Example

In the embodiment and the modification example, the ejection pulse PA is configured to include the ejection waveform element DR having the filling element d1, the potential maintenance element pwh1, and the ejecting element c1, and the residual vibration suppression element ED having the vibration suppression maintenance element pwh2 and the vibration suppression expansion element d2. Meanwhile, the present disclosure is not limited thereto, and various known waveform shapes of ejection pulses can be adopted as the first ejection pulse and the second ejection pulse.

### C9: Ninth Modification Example

In the embodiment and the modification example, in step S12 and step S24 of the determination process in step S2 of the method of adjusting the drive signal Com, the reference drive signal Com-S is supplied to the ejecting section D[m1] for any integer m1 from 1 to M. Meanwhile, the present disclosure is not limited thereto, and the reference drive signal Com-S may be supplied to all the ejecting sections D from 1 to M, or the reference drive signal Com-S may be supplied to some of the ejecting sections D from 1 to M. In this case, the ejecting section D to which the reference drive signal Com-S is supplied is an example of the “first ejecting section”, the nozzle N included in the ejecting section D to which the reference drive signal Com-S is supplied is an example of the “first nozzle”, the pressure chamber C included in the ejecting section D to which the reference drive signal Com-S is supplied is an example of the “first pressure chamber”, and the driving element E included in the ejecting section D to which the reference drive signal Com-S is supplied is an example of the “first driving element”.

Further, in step S14, step S16, and step S18, an average value of the ejection amount of the ink ejected from the plurality of ejecting sections D to which the reference drive signal Com-S is supplied may be acquired as the measured amount.

### C10: Tenth Modification Example

In the second embodiment, the reference drive signal ComA corresponding to the common reference waveform information CI is used regardless of the temperature information KI acquired by the temperature sensor 47. Meanwhile, the present disclosure is not limited to this, and the reference drive signal ComA corresponding to the reference waveform information CI corresponding to the temperature information KI may be used. For example, the information of the reference waveform information CI can be corrected in accordance with the temperature information KI acquired by the temperature sensor 47 such that a ratio of the reference potential difference ΔVhBA-S of the micro-vibration pulse PBA to the reference potential difference ΔVhA-S of the ejection pulse PA when the temperature information KI indicates a first temperature is less than a ratio of the reference potential difference ΔVhBA-S of the micro-vibration pulse PBA to the reference potential difference ΔVhA-S of the ejection pulse PA when the temperature information KI indicates a second temperature higher than the first temperature.

### C11: Eleventh Modification Example

In the second embodiment, the micro-vibration waveform element BEA of the micro-vibration pulse PBA has the potential change waveform element having the potential change width different from each other of the expansion element e4 and the contraction element e10 of the potential difference ΔV1 and the contraction element e6 and the expansion element e8 of the potential difference ΔVhBA, and the potential difference ΔV1 and the potential difference ΔVhBA are adjusted based on the upper limit micro-vibration threshold value BP1th and the lower limit micro-vibration threshold value BU1th and the upper limit micro-vibration threshold value BP2th and the lower limit micro-vibration threshold value BU2th of each of the potential difference ΔV1 and the potential difference ΔVhBA and the potential difference ΔVhA of the ejection pulse PA. Meanwhile, the present disclosure is not limited thereto. For example, when the micro-vibration waveform element BEA of the micro-vibration pulse PBA has the potential change waveform element having a potential change width different from each other, the potential change width can be set based on the potential difference ΔVhA of the ejection pulse PA, the first upper limit threshold value, and the first lower limit threshold value for the potential change waveform element having the largest potential change width.

For example, steps S132 to S142 may be performed without performing steps S112 to S122 of the flowchart illustrated in FIG. 15, and ΔV1 may be set together with the setting of the potential difference ΔVhBA.

Specifically, in step S140, the end tip potential of the expansion element e4, the end tip potential of the maintenance element e5, the end tip potential of the expansion element e8, and the end tip potential of the maintenance element e9 (the minimum potential V1), and at least one of the end tip potential of the contraction element e6 and the end tip potential of the maintenance element e7 (the maximum potential V2) of the candidate waveform information CIb may be changed such that the potential difference ΔVhBA becomes the upper limit micro-vibration threshold value BP2th. It is preferable that the ratio of the reference potential difference ΔV1-S to the reference potential difference ΔVhBA-S and the ratio of the potential difference ΔV1-S to the potential difference ΔVhBA after the setting are equal to each other.

In the same manner, in step S142, the end tip potential of the expansion element e4, the end tip potential of the maintenance element e5, the end tip potential of the expansion element e8, and the end tip potential of the maintenance element e9 (the minimum potential V1), and at least one of the end tip potential of the contraction element e6 and the end tip potential of the maintenance element e7 (the maximum potential V2) of the candidate waveform information CIb may be changed such that the potential difference ΔVhBA becomes the lower limit micro-vibration threshold value BU2th. It is preferable that the ratio of the reference potential difference ΔV1-S to the reference potential difference ΔVhBA-S and the ratio of the potential difference ΔV1-S to the potential difference ΔVhBA after the setting are equal to each other.

### C12: Twelfth Modification Example

In each of the embodiments described above, a serial-type liquid ejecting apparatus 100, which reciprocates the carriage 41 equipped with the liquid ejecting head 50, is described, but the present disclosure is also applicable to a line-type liquid ejecting apparatus in which the plurality of nozzles N are distributed over the entire width of the medium PP.

### C13: Thirteenth Modification Example

The liquid ejecting apparatus 100 described in each of the embodiments described above may be adopted in various apparatuses such as a facsimile machine and a copier, in addition to an apparatus dedicated to printing, and the application of the present disclosure is not particularly limited. Note that the application of the liquid ejecting apparatus is not limited to printing. For example, a liquid ejecting apparatus that ejects a solution of a coloring material is used as a manufacturing device that forms a color filter of a display device such as a liquid crystal display panel. In addition, a liquid ejecting apparatus that ejects a solution of a conductive material is used as a manufacturing apparatus that forms a wiring or an electrode on a wiring substrate. In addition, a liquid ejecting apparatus that ejects a solution of an organic substance related to a living body is used, for example, as a manufacturing apparatus that manufactures a biochip.

What is claimed is:

1. A driving method of a liquid ejecting apparatus including
a first ejecting section including a first nozzle that ejects a liquid onto a medium, a first pressure chamber that communicates with the first nozzle, and a first driving element that is configured to be driven to cause a pressure fluctuation in the liquid in the first pressure chamber in accordance with a supplied first drive signal, and
a first drive signal generation circuit that is configured to generate the first drive signal, and
the first drive signal including a first ejection pulse having a first ejection waveform element that changes in potential to cause the pressure fluctuation for ejecting the liquid from the first nozzle in the liquid in the first pressure chamber, and a first micro-vibration pulse having a first micro-vibration waveform element that changes in potential to cause the pressure fluctuation without ejecting the liquid from the first nozzle in the liquid in the first pressure chamber, the driving method comprising:
a determination step of determining a waveform shape of the first ejection pulse; and
a setting step of setting a potential change width of a potential change waveform element in the first micro-vibration waveform element based on a maximum potential change width in the first ejection waveform element of the first ejection pulse determined in the determination step and a first upper limit threshold value, wherein
the first upper limit threshold value is an upper limit value of the potential change width of the potential change waveform element in a micro-vibration waveform element with which the ejection of the liquid is stabilized.

2. The driving method according to claim 1, wherein
in the determination step, the waveform shape of the first ejection pulse is determined such that an amount of liquid ejected from the first nozzle when the first ejection pulse is supplied to the first driving element is a predetermined amount, and
in the setting step,
a first candidate value, which is a candidate value for the potential change width of the potential change waveform element in the first micro-vibration waveform element, is calculated based on a first ratio, which is a ratio of the maximum potential change width in the first ejection waveform element to a maximum potential change width in a reference ejection waveform element, and
when the first candidate value exceeds the first upper limit threshold value, the first upper limit threshold value is set to the potential change width of the potential change waveform element in the first micro-vibration waveform element.

3. The driving method according to claim 2, wherein
the liquid ejecting apparatus further includes
a second ejecting section including a second nozzle that ejects the liquid onto the medium, a second pressure chamber that communicates with the second nozzle, and a second driving element that is configured to be driven to cause a pressure fluctuation in the liquid in the second pressure chamber in accordance with a supplied second drive signal, and
a second drive signal generation circuit that is configured to generate the second drive signal,
the second drive signal includes a second ejection pulse having a second ejection waveform element that changes in potential to cause the pressure fluctuation for ejecting the liquid from the second nozzle in the liquid in the second pressure chamber, and a second micro-vibration pulse having a second micro-vibration waveform element that changes in potential to cause the pressure fluctuation without ejecting the liquid from the second nozzle in the liquid in the second pressure chamber,
in the determination step, a waveform shape of the second ejection pulse is determined such that an amount of liquid ejected from the second nozzle when the second ejection pulse is supplied to the second driving element is the predetermined amount,
in the setting step,
a second candidate value, which is a candidate value for a potential change width of the potential change waveform element in the second micro-vibration waveform element, is calculated based on a second ratio, which is a ratio of a maximum potential change width in the second ejection waveform element to a maximum potential change width in the reference ejection waveform element, and
when the second candidate value exceeds the first upper limit threshold value, the first upper limit threshold value is set to the potential change width of the potential change waveform element in the second micro-vibration waveform element, and
when the maximum potential change width in the first ejection waveform element and the maximum potential change width in the second ejection waveform element are different from each other, the potential change width of the potential change waveform element in the first micro-vibration waveform element and the potential change width of the potential change waveform element in the second micro-vibration waveform element are different from each other, or the potential change width of the potential change waveform element in the first micro-vibration waveform element and the potential change width of the potential change waveform element in the second micro-vibration waveform element match the first upper limit threshold value.

4. The driving method according to claim 2, wherein
in the setting step, when the first candidate value is equal to or less than the first upper limit threshold value, the first candidate value is set to the potential change width of the potential change waveform element in the first micro-vibration waveform element.

5. The driving method according to claim 2, further comprising:
an acquisition step of acquiring temperature information on a temperature of the liquid in the first ejecting section; and
a first changing step of changing the first upper limit threshold value in accordance with the temperature information, wherein
in the setting step, when the first candidate value exceeds the first upper limit threshold value changed in the first changing step, the first upper limit threshold value is set to the potential change width of the potential change waveform element in the first micro-vibration waveform element.

6. The driving method according to claim 2, wherein
in the setting step, when the first candidate value is less than a first lower limit threshold value, the first lower limit threshold value is set to the potential change width of the potential change waveform element in the first micro-vibration waveform element, and
the first lower limit threshold value is a lower limit value of the potential change width of the potential change waveform element in a micro-vibration waveform element with which thickening of the liquid is eliminated.

7. The driving method according to claim 6, further comprising:
an acquisition step of acquiring temperature information on a temperature of the liquid in the first ejecting section; and
a second changing step of changing the first lower limit threshold value in accordance with the temperature information, wherein
in the setting step, when the first candidate value is less than the first lower limit threshold value changed in the second changing step, the first lower limit threshold value is set to the potential change width of the potential change waveform element in the first micro-vibration waveform element.

8. The driving method according to claim 1, wherein
in the determination step,
a first shape, which is a candidate for the waveform shape of the first ejection pulse, is set such that an amount of liquid ejected from the first nozzle when the first ejection pulse is supplied to the first driving element is a predetermined amount, and
when a maximum potential change width of the first ejection waveform element of the first shape exceeds a second upper limit threshold value, the waveform shape of the first ejection pulse is determined such that the maximum potential change width in the first ejection waveform element is the second upper limit threshold value, and
the second upper limit threshold value is an upper limit value of a maximum potential change width in an ejection waveform element with which the ejection of the liquid is stabilized.

9. The driving method according to claim 8, wherein
in the determination step, when the maximum potential change width of the first ejection waveform element of the first shape is less than a second lower limit threshold value, the waveform shape of the first ejection pulse is determined such that the maximum potential change width of the first ejection waveform element is the second lower limit threshold value, and
the second lower limit threshold value is a lower limit value of a maximum potential change width in an ejection waveform element with which the liquid to be ejected from the first nozzle is ejected at a predetermined ejection velocity.

10. A liquid ejecting apparatus comprising:
a first ejecting section including a first nozzle that ejects a liquid onto a medium, a first pressure chamber that communicates with the first nozzle, and a first driving element that is configured to be driven to cause a pressure fluctuation in the liquid in the first pressure chamber in accordance with a supplied first drive signal;
a first drive signal generation circuit that is configured to generate the first drive signal; and
a control circuit that controls the first drive signal generation circuit, wherein
the first drive signal includes a first ejection pulse having a first ejection waveform element that changes in potential to cause the pressure fluctuation for ejecting the liquid from the first nozzle in the liquid in the first pressure chamber, and a first micro-vibration pulse having a first micro-vibration waveform element that changes in potential to cause the pressure fluctuation without ejecting the liquid from the first nozzle in the liquid in the first pressure chamber,
the control circuit
determines a waveform shape of the first ejection pulse, and
sets a potential change width of a potential change waveform element in the first micro-vibration waveform element based on a maximum potential change width in the first ejection waveform element of the determined first ejection pulse and a first upper limit threshold value, and
the first upper limit threshold value is an upper limit value of the potential change width of the potential change waveform element in a micro-vibration waveform element with which the ejection of the liquid is stabilized.
